(19) United States
(12) Patent Application Publication
(10) Pub. No.: US 2025/0390747 A1
(43) Pub. Date: Dec. 25, 2025

(54) TRAINING METHOD FOR IMAGE GENERATION MODEL, COMPUTER DEVICE, AND STORAGE MEDIUM

(71) Applicant: TENCENT TECHNOLOGY (SHENZHEN) COMPANY LIMITED, Shenzhen (CN)

(72) Inventor: Hui GUO, Shenzhen (CN)

(21) Appl. No.: 19/317,133

(22) Filed: Sep. 3, 2025

Related U.S. Application Data
(63) Continuation of application No. PCT/CN2023/136642, filed on Dec. 6, 2023.

(30) Foreign Application Priority Data
Jul. 4, 2023 (CN) 202310812476.4

(51) Int. Cl. G06N 3/08; G06N 3/0475; G06N 3/0499; G06T 3/4053; G06T 7/00; G06T 11/60

(52) U.S. Cl. CPC G06N 3/08; G06N 3/0475; G06N 3/0499; G06T 3/4053; G06T 7/0002; G06T 11/60; G06T 2207/30168

(57) ABSTRACT

A training method includes obtaining a training sample set of an image generation model, the training sample set including at least one image-text pair each including a character name and a matching character image; inputting the character name into a representation extraction module to generate a character representation corresponding to the character name; inputting a random noise image into a forward processing module of a diffusion model to generate a latent space representation corresponding to the random noise image; inputting the character representation and the latent space representation into a backward processing module of the diffusion model and a bypass module of the image generation model, to generate a predicted image corresponding to the character name; and adjusting parameters of the representation extraction module and the bypass module based on a difference between the predicted image and the character image, to obtain a trained image generation model.

### CROSS-REFERENCES TO RELATED APPLICATIONS

This application is a continuation application of PCT Patent Application No. PCT/CN2023/136642, filed on Dec. 6, 2023, which claims priority to Chinese Patent Application No. 202310812476.4, filed on Jul. 4, 2023, all of which is incorporated herein by reference in their entirety.

### FIELD OF THE TECHNOLOGY

The present disclosure relates to the field of artificial intelligence (AI) technologies, and in particular, to a training method and apparatus for an image generation model, a device, and a storage medium.

### BACKGROUND OF THE DISCLOSURE

With the development of diffusion models, the ability to create text-to-image has been greatly improved. When a user inputs a text prompt, the model can perform a series of operations on a random noise image to generate a predicted image related to the text.

Fine-tuning training of the diffusion model is configured to train a newly added sample that were not involved in the original training process of the diffusion model, so that the diffusion model can generate a predicted image corresponding to the newly added text. Often, for the fine-tuning training of the diffusion model, an image-text pair that needs to be trained is inputted into the model. For example, a character name and a character image of “Zhang XX” may be inputted into a model for training, so that a corresponding character image may be generated based on the inputted character name of “Zhang XX” during application of the diffusion model.

However, the fine-tuning method tends to alter well-trained parameters of the model, causing overfitting of the model, and resulting in degradation of the quality of the generated image.

### SUMMARY

One embodiment of the present disclosure provides a training method for an image generation model, performed by a computer device. The method includes obtaining a training sample set of the image generation model, the training sample set comprising at least one image-text pair, and each image-text pair comprising a character name and a character image that have a matching relationship; inputting the character name in the image-text pair into a representation extraction module of the image generation model to generate a character representation corresponding to the character name; inputting a random noise image into a forward processing module of a diffusion model of the image generation model to generate a latent space representation corresponding to the random noise image, the diffusion model being pre-trained; inputting the character representation and the latent space representation into a backward processing module of the diffusion model and a bypass module of the image generation model, to generate a predicted image corresponding to the character name; and adjusting parameters of the representation extraction module and the bypass module based on a difference between the predicted image and the character image, to obtain a trained image generation model.

Another embodiment of the present disclosure provides a computer device. The computer device includes one or more processors and a memory containing a computer program that, when being executed, causes the one or more processors to perform: obtaining a training sample set of the image generation model, the training sample set comprising at least one image-text pair, and each image-text pair comprising a character name and a character image that have a matching relationship; inputting the character name in the image-text pair into a representation extraction module of the image generation model to generate a character representation corresponding to the character name; inputting a random noise image into a forward processing module of a diffusion model of the image generation model to generate a latent space representation corresponding to the random noise image, the diffusion model being pre-trained; inputting the character representation and the latent space representation into a backward processing module of the diffusion model and a bypass module of the image generation model, to generate a predicted image corresponding to the character name; and adjusting parameters of the representation extraction module and the bypass module based on a difference between the predicted image and the character image, to obtain a trained image generation model.

Another embodiment of the present disclosure provides a non-transitory computer-readable storage medium containing a computer program that, when being executed, causes the one or more processors to perform: obtaining a training sample set of the image generation model, the training sample set comprising at least one image-text pair, and each image-text pair comprising a character name and a character image that have a matching relationship; inputting the character name in the image-text pair into a representation extraction module of the image generation model to generate a character representation corresponding to the character name; inputting a random noise image into a forward processing module of a diffusion model of the image generation model to generate a latent space representation corresponding to the random noise image, the diffusion model being pre-trained; inputting the character representation and the latent space representation into a backward processing module of the diffusion model and a bypass module of the image generation model, to generate a predicted image corresponding to the character name; and adjusting parameters of the representation extraction module and the bypass module based on a difference between the predicted image and the character image, to obtain a trained image generation model.

### BRIEF DESCRIPTION OF THE DRAWINGS

FIG. 1 is a schematic diagram of a solution implementation environment according to an embodiment of the present disclosure.

FIG. 2 is a flowchart of a training method for an image generation model according to an embodiment of the present disclosure.

FIG. 3 is a flowchart of a training method for an image generation model according to another embodiment of the present disclosure.

FIG. 4 is a schematic structural diagram of a bypass network and a denoising network according to an embodiment of the present disclosure.

FIG. 5 is a schematic structural diagram of a Query, Key, Value (QKV) network according to an embodiment of the present disclosure.

FIG. 6 is a schematic structural diagram of an image generation model according to an embodiment of the present disclosure.

FIG. 7 is a flowchart of a method for generating a training sample set for an image generation model according to an embodiment of the present disclosure.

FIG. 8 is a schematic diagram of a makeup having a strong makeup application effect according to an embodiment of the present disclosure.

FIG. 9 is a schematic diagram of a makeup having a natural makeup application effect according to an embodiment of the present disclosure.

FIG. 10 is a schematic diagram of an optimization effect of a face super-resolution model according to an embodiment of the present disclosure.

FIG. 11 is a schematic diagram of an image enhancement processing process according to an embodiment of the present disclosure.

FIG. 12 is a schematic diagram of an effect of an image enhancement processing process on an image generation model according to an embodiment of the present disclosure.

FIG. 13 is a flowchart of an image generation method based on an image generation model according to another embodiment of the present disclosure.

FIG. 14 is a schematic diagram of a process of generating a character representation library based on a character representation according to an embodiment of the present disclosure.

FIG. 15 is a schematic diagram of replacing an original character representation with a representation mean according to an embodiment of the present disclosure.

FIG. 16 is a schematic diagram of replacing an original character representation with a character representation with a highest similarity according to an embodiment of the present disclosure.

FIG. 17 is a schematic diagram of an application interface of an image generation model according to an embodiment of the present disclosure.

FIG. 18 is a block diagram of a training apparatus for an image generation model according to an embodiment of the present disclosure.

FIG. 19 is a block diagram of an image generation apparatus based on an image generation model according to an embodiment of the present disclosure.

FIG. 20 is a structural block diagram of a computer device according to an embodiment of the present disclosure.

### DESCRIPTION OF EMBODIMENTS

To make objectives, technical solutions, and advantages of the present disclosure clearer, embodiments of the present disclosure are further described in detail below with reference to the accompanying drawings.

Artificial intelligence (AI) is a theory, a method, a technology, and an application system that uses a digital computer or a machine controlled by the digital computer to simulate, extend, and expand human intelligence, perceive the environment, acquire knowledge, and use the knowledge to obtain the best result. In other words, AI is a comprehensive technology of computer science, which attempts to understand essence of intelligence and produces a new intelligent machine that can respond in a manner similar to human intelligence. AI is to study the design principles and implementation methods of various intelligent machines, to enable the machines to have the functions of perception, reasoning, and decision-making.

The AI technology is a comprehensive discipline, and involves a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

Machine learning (ML) is an interdisciplinary field that spans multiple domains, e.g., involving a plurality of disciplines such as the probability theory, statistics, approximation theory, convex analysis, and algorithm complexity theory. ML specializes in studying how a computer simulates or implements a learning behavior of human to obtain new knowledge or skills and reorganize an existing knowledge structure to keep improving its performance. ML is the core of AI, is a basic way to make the computer intelligent, and is applied to various fields of AI. The ML and the deep learning generally include technologies such as an artificial neural network, a confidence network, reinforcement learning, transfer learning, inductive learning, and learning from demonstration.

The CV technology is a field of science that studies how to enable a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. The large model technology brings an important change to the development of the CV technology. Pre-training models in vision fields such as a Swin Transformer, a vision transformer (ViT), a vision mixture-of-experts (V-MoE) model, and a masked autoencoder (MAE) may be quickly and widely applied to specific downstream tasks after fine tuning. The CV technology generally includes technologies such as image processing, image recognition, image semantic understanding, image retrieval, optical character recognition (OCR), video processing, video semantic understanding, video content/behavior recognition, three-dimensional object reconstruction, three-dimensional (3D) technology, virtual reality (VR), augmented reality (AR), and simultaneous localization and mapping, and further includes common biometric recognition technologies such as face recognition and fingerprint recognition.

With the research and progress of AI technologies, the AI technology has been studied and applied in a plurality of fields such as a common smart home, a smart wearable device, a virtual assistant, a smart speaker, smart marketing, unmanned driving, automatic driving, an unmanned aerial vehicle, a robot, AI generated content (AIGC), smart medical care, smart customer service, VR, and AR. It is believed that with the development of technologies, the AI technology is to be applied in more fields and plays increasingly important value.

The technical solutions of the present disclosure mainly involve the ML technology and the CV technology in the AI technology, and mainly involve a training and using process of an image generation model.

Before the technical solutions of the present disclosure are described, some terms involved in the present disclosure are explained first. As an optional solution, the following related explanations may be arbitrarily combined with the technical solutions of the embodiments of the present disclosure, and all fall within the protection scope of the embodiments of the present disclosure. The embodiments of the present disclosure include at least part of the following content.

A pre-training model (PTM), also referred to as a cornerstone model or a large model, refers to a deep neural network (DNN) having a large parameter, which is trained on massive unmarked data. The PTM is configured to extract a common feature from the data through a function approximation capability of the large-parameter DNN, which is applicable to downstream tasks through technologies such as fine tuning, high-efficient parameter fine tuning, and prompt tuning. Therefore, the pre-training model may achieve an ideal effect in a few-shot or zero-shot scenario. The PTM may be classified into a language model, vision models (Swin Transformer, ViT, and V-MoE), a speech model, a multi-modal model, and the like based on data modalities to be processed. The multi-modal model refers to a model that establishes feature representations of two or more data modalities. The pre-training model is an important tool for outputting AIGC, or may be used as a common interface for connecting a plurality of specific task models. The diffusion model and the like in the embodiments of the present disclosure may be considered as a pre-training model.

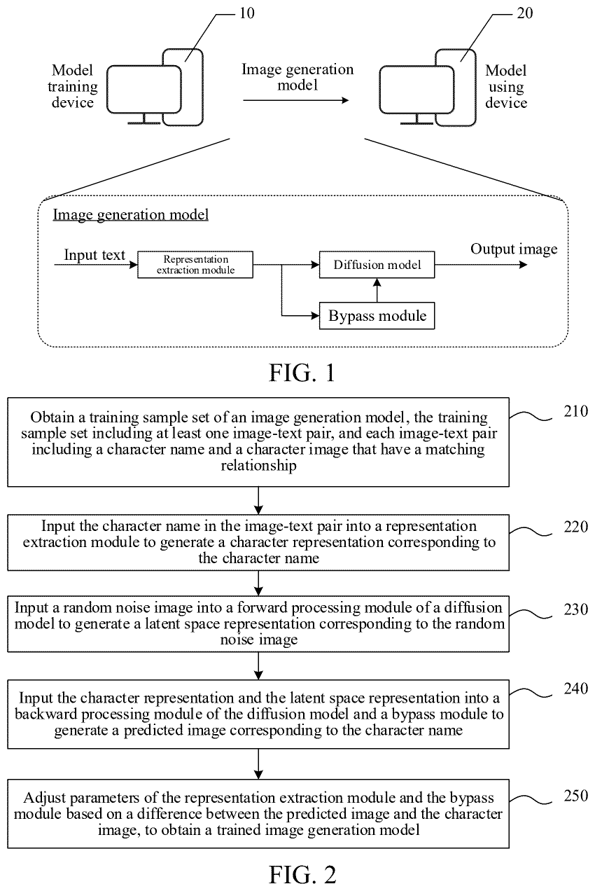

FIG. 1 is a schematic diagram of an implementation environment according to an embodiment of the present disclosure. The solution implementation environment may be implemented as a training and using system of an image generation model. The solution implementation environment may include a model training device 10 and a model using device 20.

The model training device 10 may be an electronic device such as a mobile phone, a tablet computer, a notebook computer, a desktop computer, a smart television, a multi-media playback device, an on-board terminal, a server, an intelligent robot, or some other electronic devices having strong computing power. The model training device 10 is configured to train an image generation model.

In this embodiment of the present disclosure, the image generation model is a machine learning model trained based on a training method of an image generation model, which is configured to generate, based on an input text including a character name, an output image that matches the input text. The model training device 10 may train the image generation model in a manner of machine learning, to cause the image generation model to have the ability to generate, based on the input text, the output image that matches the input text. For a specific model training method, reference may be made to the following embodiments.

The image generation model includes a representation extraction module, a diffusion model, and a bypass module. The representation extraction module is configured to obtain a text representation of the input text. The diffusion model is configured to gradually remove noise in a noise image based on the input text, to generate an output image that matches the input text. The bypass module is configured to assist the diffusion model in generating the output image that matches the input text, and an output of the bypass module that is weighted is used as an input of a specific network in the diffusion model, to further remove the noise in the noise image based on the input text. The representation extraction module and the bypass module are functional modules based on neural network learning.

In this embodiment of the present disclosure, the input text is inputted into the image generation model. First, the representation extraction module generates the text representation of the input text, and then the diffusion model and the bypass module gradually denoise the noise image based on the text representation, to generate the output image that matches the input text.

The trained image generation model may be deployed in the model using device 20 for use. The model using device 20 may be a terminal device such as a mobile phone, a tablet computer, a notebook computer, a desktop computer, a smart television, a multi-media playback device, an on-board terminal, or an intelligent robot, or may be a server. When an output image that matches the input text needs to be generated based on the input text, the model using device 20 may implement the foregoing function through the trained image generation model.

The model training device 10 and the model using device 20 may be two independent devices, or may be the same device. When the model training device 10 and the model using device 20 are the same device, the model training device 10 may be deployed in the model using device 20.

In this embodiment of the present disclosure, each operation may be performed by a computer device. The computer device refers to an electronic device having data computing, processing, and storage functions. The computer device may be a terminal device such as a mobile phone, a tablet computer, a notebook computer, a desktop computer, a smart television, a multi-media playback device, an on-board terminal, or an intelligent robot, or may be a server. The server may be an independent physical server, or may be a server cluster composed of a plurality of physical servers or a distributed system, and may further be a cloud server providing a cloud computing service. The computer device may be the model training device 10 or the model using device 20 in FIG. 1.

FIG. 2 is a flowchart showing a training method for an image generation model according to an embodiment of the present disclosure. The image generation model includes a representation extraction module, a bypass module, and a pre-trained diffusion model. Each operation of the method may be performed by a computer device. The method may include at least one of the following operations 210-250.

Before the specific solutions of the present disclosure are introduced, modules included in the image generation model mentioned in the present disclosure are first described.

In some embodiments, the image generation model includes a representation extraction module, a diffusion model, and a bypass module.

In some embodiments, the representation extraction module is configured to obtain a text representation of a text. In other words, the representation extraction module is a module configured to perform representation extraction on the input text to obtain the text representation of the text. In some embodiments, an input of the representation extraction module is a character name, and an output is a character representation of the character name. Exemplarily, the representation extraction module includes at least one feature extraction layer.

In some embodiments, the diffusion model is configured to gradually remove noise in a noise image based on the character representation, to generate an output image that matches the character name. Exemplarily, the diffusion model includes a forward processing module and a backward processing module. The forward processing module is configured to implement a noise addition process, and the backward processing module is configured to implement a denoising process. In some embodiments, an input of the forward processing module of the diffusion model is an image, and an output is an image feature obtained after noise addition is performed on the image for a plurality of times. In this case, the image feature is also referred to as a latent space representation. In some embodiments, an input of the forward processing module of the diffusion model is a random noise image, and an output is a latent space representation corresponding to the random noise image. In some embodiments, an input of the backward processing module of the diffusion model is a latent space representation, an output is a denoised latent space representation obtained after denoising is performed on the latent space representation for a plurality of times, and then decoding is performed to obtain a predicted image. In some embodiments, an input of the backward processing module of the diffusion model is a latent space representation, and an output is an image feature of the predicted image before decoding (namely, a denoised latent space representation). In some other embodiments, in addition to the latent space representation corresponding to the random noise image, an input of the backward processing module of the diffusion model further includes an output of the foregoing representation extraction module, namely, a character representation of a character name. In this case, the input of the backward processing module of the diffusion model includes a latent space representation and a character representation that correspond to the random noise image, and an output is a predicted image.

In some embodiments, the image generation model further includes an encoder and a decoder. Exemplarily, the encoder is connected to the forward processing module of the diffusion model, and the decoder is connected to the backward processing module of the diffusion model. Exemplarily, the random noise image is encoded through the encoder, to obtain an initial feature vector corresponding to the random noise image, the initial feature vector is inputted into the forward processing module of the diffusion model, and T noise addition networks included in the forward processing module of the diffusion model perform noise addition on an initial feature, to obtain a latent space representation corresponding to the random noise image. Exemplarily, the latent space representation is denoised based on the character representation through T denoising networks included in the backward processing module of the diffusion model and T bypass networks included in the bypass module, to obtain a denoised latent space representation. For a specific process, refer to the following embodiment. Exemplarily, the decoder is configured to decode the denoised latent space representation, to obtain a predicted image. T is a positive integer.

In some embodiments, the bypass module is configured to assist the diffusion model in generating an output image that matches the input text, an input of the bypass module includes a latent space representation and a character representation that correspond to the random noise image, and an output of the bypass module is weighted and used as an input of a denoising network of the backward processing module of the diffusion model, to further remove noise in the noise image based on the character representation. In some embodiments, the bypass module may also be referred to as a control network. The bypass module is configured to involve the character representation in each denoising process of the latent space representation performed by the backward processing module of the diffusion model, so that the character representation can affect each denoising process of the latent space representation, thereby affecting a finally outputted predicted image, so that the predicted image can be consistent with a character name represented by the character representation.

The representation extraction module, the diffusion model, and the bypass module are functional modules based on neural network learning. In some embodiments, the diffusion model is a pre-training model. Parameters of the forward processing module and the backward processing module of the diffusion model all remain unchanged, and do not participate in a subsequent model training process. In some other embodiments, the diffusion model is a pre-training model. The parameter of the forward processing module (the noise addition process) of the diffusion model does not remain unchanged, and does not participate in subsequent training, and the parameter of the backward processing module (the denoising process) of the diffusion model participates in the subsequent training. A specific training module of the diffusion model is not limited in the present disclosure.

Operation 210: Obtain a training sample set of the image generation model, the training sample set including at least one image-text pair, and each image-text pair including a character name and a character image that have a matching relationship.

The character name refers to a name of any character, which may be a name of a real character, or may be a name of a virtual character. When the character name is a name of a real character, the character name may be a name of a well-known character, for example, a name of a well-known scientist, a name of a well-known athlete, or a name of a well-known actor; or may be a name of an unknown ordinary person, for example, a name of a classmate, a colleague, a teacher, or a neighbor. When the character name is a name of a virtual character, the character may not be limited to a human form, which may include an animal form, or any autonomously created virtual form, for example, may be a name of a character in a movie or television play, may be a name of an animation character, or may be a name of a game role.

The character name may be in a form of text, numbers, or strings. This is not limited in the present disclosure. If the character name is in the form of text, the character name may refer to a name of a person, for example, “Zhang XX”.

A character image is an image including an appearance and an expression of a character. The character image may be a color character image, or may be a black and white character image. In this embodiment of the present disclosure, the character image included in the training sample set is a color character image.

The matching relationship between the character name and the character image means that the character image includes an image of a character corresponding to the character name. For example, when “Zhang XX” has a matching relationship with a character image, it indicates that the character image includes an image of “Zhang XX”, and when “Li XX” does not have a matching relationship with a character image, it indicates that the character image does not include an image of “Li XX”. One character name may have a matching relationship with a plurality of character images, and one character image has a matching relationship with only one character name. One character name may form an image-text pair with a plurality of character images that have matching relationships with the character name. Therefore, at least one image-text pair included in the training sample set may include a plurality of image-text pairs of the same character name.

Operation 220: Input a character name in an image-text pair into a representation extraction module to generate a character representation corresponding to the character name.

Each character name in the image-text pair is used as an input of the representation extraction module, and the representation extraction module generates the character representation corresponding to each character name. One character name corresponds to one character representation, one character image has a matching relationship with one character representation, and one character name has a matching relationship with a plurality of character images.

The character representation may be a representation in the form of a vector, or may be a representation in the form of a matrix. The character representation is configured to represent a feature of a character, including at least one of an appearance feature, a gender feature, an age feature, and an identity feature of the character.

Operation 230: Input a random noise image into a forward processing module of a diffusion model to generate a latent space representation corresponding to the random noise image.

In some embodiments, the forward processing module of the diffusion model represents a forward process of the diffusion model. The forward process of the diffusion model is also referred to as a diffusion process, which is configured for adding noise to the input data successively until the input data approaches pure noise. Exemplarily, the whole diffusion process may be a parameterized Markov chain. In some embodiments, the forward processing module of the diffusion model includes T noise addition networks, the T noise addition networks being in one-to-one correspondence with T denoising networks included in a backward processing module of the following diffusion model. The T noise addition networks are configured to implement the noise addition process.

The diffusion model in the embodiments of the present disclosure is a pre-trained diffusion model, and has a certain capability of generating a target image based on a noise image. An open source model structure and model parameter may be used as a model parameter of the diffusion model. This is not limited in the present disclosure, and a pre-training process of the diffusion model is not described in detail.

In some embodiments, the random noise image is encoded through a first encoder, to obtain an initial feature vector of the random noise image. Noise addition is performed on the initial feature vector for T times through the forward processing module of the diffusion model, to generate the latent space representation corresponding to the random noise image, T being a positive integer.

The random noise image refers to a randomly generated noise image. The random noise image may be correspondingly generated by random numbers. Different random numbers correspond to different random noise images. The random number refers to any number. The random noise images corresponding to different random numbers have different image features, which may be different style features of an image, for example, may be a style feature with strong colors in a picture, or may be a style feature with light colors in a picture, or may be different scene features of an image, for example, may be a scene feature of a city, or may be a scene feature of a grassland.

The first encoder refers to any encoder. The initial feature vector of the random noise image has a feature of the random noise image. An initial feature of the random noise image is used as input data of the forward processing module of the diffusion model. Noise is added to the initial feature vector successively through a diffusion process. The initial feature vector successively loses the feature thereof. After noise addition is performed for T times, the initial feature vector becomes a latent space representation without any feature. In other words, the latent space representation refers to a representation of a pure noise image without image features that corresponds to the random noise image. A form of the latent space representation is the same as a form of the character representation, which may be a representation in the form of a vector, or may be a representation in the form of a matrix.

Operation 240: Input the character representation and the latent space representation into a backward processing module of the diffusion model and a bypass module to generate a predicted image corresponding to the character name.

In some embodiments, the backward processing module of the diffusion model represents a backward process of the diffusion model, and the backward process of the diffusion model is configured for successively removing noise from input data based on a constraint condition, to generate a target image. Exemplarily, the whole backward process of the diffusion model may also be a parameterized Markov chain. The bypass module is configured to assist the backward processing module of the diffusion model in generating a target image, and an output of the bypass module is weighted and used as an input of a specific network in the diffusion model, to further remove noise in the input data based on the input data.

The latent space representation and the character representation are used as input data of the backward processing module of the diffusion model and the bypass module, and the backward processing module of the diffusion model and the bypass module perform successive denoising constraint on latent space features based on the character representation, so that the generated predicted image satisfies a constraint requirement of the character representation.

Operation 250: Adjust parameters of the representation extraction module and the bypass module based on a difference between the predicted image and the character image, to obtain a trained image generation model.

In some embodiments, the parameters of the representation extraction module and the bypass module may be adjusted simultaneously based on the difference between the predicted image and the character image. In some embodiments, a loss function value is determined based on the difference between the predicted image and the character image. In some embodiments, the parameters of the representation extraction module and the bypass module are adjusted based on the loss function value, to obtain a trained image generation model. In some embodiments, the parameters of the representation extraction module and the bypass module are adjusted with a goal of minimizing the loss function value, to obtain a trained image generation model. In some embodiments, the parameters of the representation extraction module and the bypass module are adjusted in a manner of forward gradient update based on the loss function value, to obtain a trained image generation model. In some embodiments, the parameters of the representation extraction module and the bypass module are adjusted in a manner of backward gradient update based on the loss function value, to obtain a trained image generation model.

In some embodiments, considering that functions of the representation extraction module and the bypass module are different, and convergence speeds of the two modules are also different, simultaneous training of the representation extraction module and the bypass module causes a module with slow convergence to be unable to learn good enough information, which further causes a decrease in the convergence speed during training of a module. Therefore, when the parameters of the representation extraction module and the bypass module are adjusted, each round of iterative adjustment is to adjust the parameter of one of the representation extraction module and the bypass module, a parameter of the other module remaining unchanged, and the parameters of the representation extraction module and the bypass module being adjusted alternately. In addition, a problem that continuous training of a single module easily causes overfitting of an overall model is also avoided.

In the technical solutions provided in the embodiments of the present disclosure, on the one hand, the bypass module is added to the image generation model, so that during iterative training of the image generation model, only the representation extraction module and the bypass module may be trained, and the diffusion model does not need to be trained, to avoid a problem of model overfitting caused by the diffusion model forgetting a trained parameter as a result of training the pre-trained diffusion model again, thereby improving quality of an image generated by the model. On the other hand, the used training sample set includes a plurality of character images corresponding to a same character name, so that the trained image generation model may generate different character representations of the same character name, thereby meeting different character image generation requirements and improving functional diversity of the image generation model.

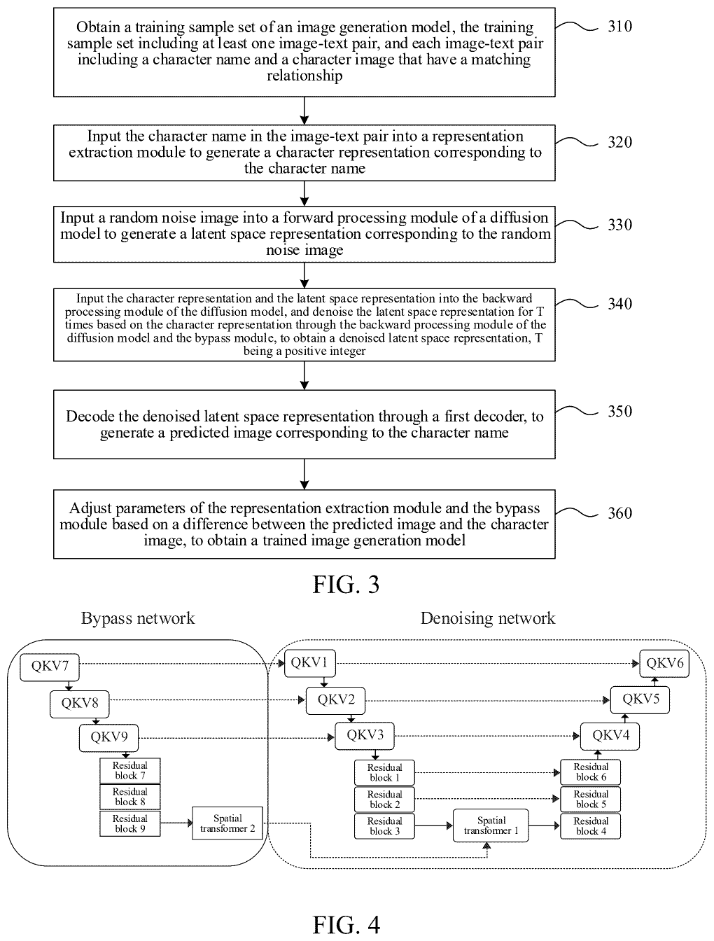

FIG. 3 is a flowchart showing a training method for an image generation model according to another embodiment of the present disclosure. Each operation of the method may be performed by a computer device. The method may include at least one of the following operations 310-360.

Operation 310: Obtain a training sample set of the image generation model, the training sample set including at least one image-text pair, and each image-text pair including a character name and a character image that have a matching relationship.

Operation 320: Input a character name in an image-text pair into a representation extraction module to generate a character representation corresponding to the character name.

Operation 330: Input a random noise image into a forward processing module of a diffusion model to generate a latent space representation corresponding to the random noise image.

Operation 340: Input the character representation and the latent space representation into the backward processing module of the diffusion model, and denoise the latent space representation for T times based on the character representation through the backward processing module of the diffusion model and the bypass module, to obtain a denoised latent space representation, T being a positive integer.

In some embodiments, noise addition is performed on an initial feature vector for T times through the forward processing module of the diffusion model, to generate the latent space representation corresponding to the random noise image. The backward processing module of the diffusion model and the bypass module denoise the latent space representation for T times based on the character representation, to obtain the denoised latent space representation.

In some embodiments, the backward processing module of the diffusion model includes T denoising networks, the denoising networks including a downsampling network and an upsampling network, and the bypass module including T bypass networks.

The T denoising networks are connected in series, and the T bypass networks are respectively connected in parallel with the T denoising networks. The denoising the latent space representation once by the backward processing module of the diffusion model and the bypass module based on the character representation is to denoise the latent space representation based on the character representation through one denoising network and one bypass network, and denoising is performed for T times to obtain a denoised latent space representation.

Operation 340 includes at least one sub-operation of operations 340-I, 340-II and 340-III, for example.

Operation 340-I: Respectively input, in an i^{th} denoising process, the character representation and an i^{th} input representation into an i^{th} bypass network and a downsampling network of an i^{th} denoising network, to obtain output data of the i^{th} bypass network and output data of the downsampling network of the i^{th} denoising network.

The i^{th} input representation refers to a latent space representation obtained after denoising for i−1 times, a first input representation being a latent space representation.

The i^{th} input representation is denoised based on the character representation by inputting the character representation and the i^{th} input representation into the i^{th} bypass network and the downsampling network of the i^{th} denoising network respectively, to obtain output data of the i^{th} bypass network and output data of the downsampling network of the i^{th} denoising network.

In some embodiments, the i^{th} bypass network and the downsampling network of the i^{th} denoising network have the same structure, the i^{th} bypass network including N cascaded first network units, and the downsampling network of the i^{th} denoising network including N cascaded second network units, N being an integer greater than 1.

Each of the first network units refers to a Query, Key, Value (QKV) unit. The i^{th} bypass network includes at least one of N cascaded QKV units, M cascaded residual blocks, and a spatial transformer. Each of the second network units refers to a QKV unit. The i^{th} denoising network includes N cascaded QKV units, M cascaded residual blocks, and a spatial transformer.

Since the i^{th} bypass network and the downsampling network of the i^{th} denoising network have the same structure, in some embodiments, a parameter of the downsampling network of the i^{th} denoising network may be used as an initialized parameter of the i^{th} bypass network.

The parameter of the downsampling network of the i^{th} denoising network is only used as the initialized parameter of the i^{th} bypass network. In the subsequent iterative adjustment, the parameter of the i^{th} bypass network is updated without changing the parameter of the downsampling network of the i^{th} denoising network.

In some embodiments, the initialized parameter of the i^{th} bypass network may also be set in a manner of random determination. However, with respect to the manner of randomly determining the initialization parameter of the bypass network, a pre-training parameter of a downsampling network of a denoising network is used as the initialized parameter of the bypass network, which helps increase a convergence speed of the bypass network and improve training efficiency.

Exemplarily, pre-training parameters of the N cascaded QKV units, the M cascaded residual blocks, and the spatial transformer in the i^{th} denoising network may be used as initialization parameters of the N cascaded QKV units, the M cascaded residual blocks, and the spatial transformer in the i^{th} bypass network.

FIG. 4 is a schematic structural diagram showing a bypass network and a denoising network. It may be seen that a structure of the bypass network is the same as a structure of the downsampling network of the denoising network. The downsampling network in FIG. 4 includes 3 cascaded QKV units, 3 cascaded residual blocks, and a spatial transformer. The bypass network also includes 3 cascaded QKV units, 3 cascaded residual blocks, and a spatial transformer. An upsampling network includes 3 cascaded residual blocks and 3 cascaded QKV units. QKV7, QKV8, and QKV9 have the same structure as QKV1, QKV2, and QKV3, and initialization parameters of QKV7, QKV8, and QKV9 are pre-training parameters of QKV1, QKV2, and QKV3. The residual block 7, the residual block 8, and the residual block 9 have the same structure as the residual block 1, the residual block 2, and the residual block 3, and initialization parameters of the residual block 7, the residual block 8, and the residual block 9 are pre-training parameters of the residual block 1, the residual block 2, and the residual block 3. A spatial transformer 2 has the same structure as a spatial transformer 1, and initialization parameter of the spatial transformer 2 is a pre-training parameter of the spatial transformer 1.

In an i^{th} denoising process, a character representation and an i^{th} input representation are respectively used as input data of an i^{th} bypass network and a downsampling network of an i^{th} denoising network, to obtain output data of a spatial transformer of the i^{th} bypass network and output data of a spatial transformer of the downsampling network of the i^{th} denoising network.

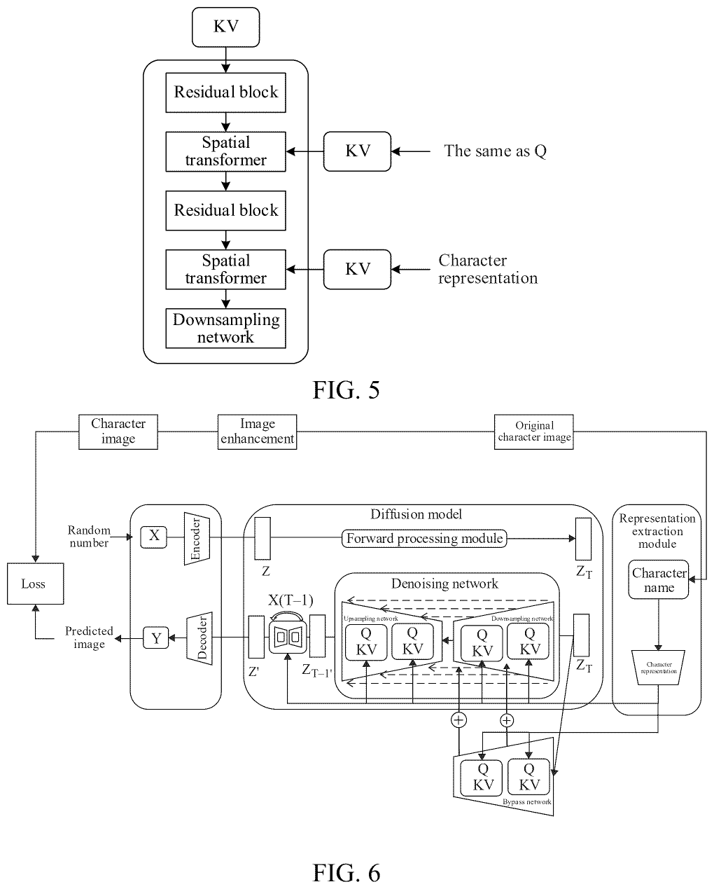

FIG. 5 is a schematic structural diagram showing a QKV network. A QKV network may include a plurality of stacked residual blocks and a spatial transformer. The residual network is configured to learn features of more layers, and the spatial transformer is configured to implement a calculation process of a QKV. Query (Q) is to match others, representing information to be controlled, Key (K) is to be matched, representing information to be controlled, and Value (V) refers to information to be extracted, representing information about an input feature.

In the embodiments of the present disclosure, the inputted Q refers to an i^{th} input representation, KV refers to a character representation, and Q is controlled through KV to obtain Q controlled through KV. In a calculation process of a first QKV in FIG. 5, KV is the same as the inputted Q, to prevent overfitting of QKV network training, and Q controlled through KV is outputted to a second residual block. In a calculation process of a second QKV, Q is an output of a previous QKV calculation process, and KV is a character representation. An input representation after being controlled through the character representation is obtained, and then an output of the calculation process of the second QKV is used as an input of another module in the downsampling network.

In some embodiments, weighted summation is performed on output data of a j^{th} first network unit included in the i^{th} bypass network and output data of a j^{th} second network unit included in the downsampling network of the i^{th} denoising network, and then a result of the weighted summation is used as input data of a (j+1)^{th} second network unit, j being a positive integer less than N.

Referring to FIG. 4, in the i^{th} denoising process, the character representation and the i^{th} input representation are respectively used as input data of QKV7 and QKV1. Weighted summation is performed on output data of QKV7 and output data of QKV1, and then a result of the weighted summation is used as input data of QKV2. The process may be represented as output_QKV1+a*output_QKV7=input_QKV2, a being a number greater than 0. Weighted summation is performed on output data of QKV8 and output data of the QKV2, and then a result of the weighted summation is used as input data of QKV3, and weighted summation is performed on output data of QKV9 and output data of the QKV3, and then a result of the weighted summation is used as input data of a residual block 1.

Operation 340-II: Obtain input data of an upsampling network of the i^{th} denoising network based on the output data of the i^{th} bypass network and the output data of the downsampling network of the i^{th} denoising network.

Exemplarily, weighted summation may be performed on the output data of the i^{th} bypass network and the output data of the downsampling network of the i^{th} denoising network, and then a result of the weighted summation is used as input data of the upsampling network of the i^{th} denoising network.

Referring to FIG. 4, weighted summation is performed on output data of a spatial transformer 2 of a bypass network and output data of a spatial transformer 1 of a downsampling network, and then a result of the weighted summation may be used as input data of an upsampling network of a denoising network, namely, used as input data of a residual block 4. In addition, the output data of the QKV1, QKV2, QKV3 and the residual blocks 1 and 2 of the downsampling network are also respectively used as input data of the residual blocks 5 and 6, and the QKV4, QKV5, and QKV6 of the upsampling network.

Operation 340-III: Input the character representation and the input data of the upsampling network of the i^{th} denoising network into the upsampling network of the i^{th} denoising network, to obtain an i^{th} output representation, i being a positive integer less than or equal to T, a first input representation being the latent space representation, the i^{th} output representation being used as an (i+1)^{th} input representation, and a T^{th} output representation being the denoised latent space representation.

Referring to FIG. 4, the input data of the upsampling network of the denoising network includes data obtained after the weighted summation is performed on the character representation, the output data of the QKV1, QKV2, and QKV3, the output data of the residual blocks 1 and 2, and the output data of the spatial transformer 1. After weighted summation is performed on the output data of the spatial transformer 1 and the output data of the spatial transformer 2, a result of the weighted summation is used as input data of a residual block 4; after weighted summation is performed on the output data of the residual block 2 and output data of the residual block 4, a result of the weighted summation is used as input data of a residual block 5; after weighted summation is performed on the output data of the residual block 1 and the output data of the residual block 5, a result of the weighted summation is used as input data of a residual block 6; after weighted summation is performed on the output data of the QKV3 and the output data of the residual block 6, a result of the weighted summation is used as input data of the QKV4; after weighted summation is performed on the output data of the QKV2 and output data of the QKV4, a result of the weighted summation is used as input data of QKV5; and after weighted summation is performed on the output data of the QKV1 and output data of the QKV5, a result of the weighted summation is used as input data of QKV6, so as to obtain output data of the QKV6, namely, obtain output data of an upsampling network of a denoising network as an output representation of the denoising network.

A first input representation corresponding to a first denoising network and a first bypass network is a latent space representation, an output representation of the i^{th} denoising network is used as an i^{th} input representation corresponding to the i^{th} denoising network and the i^{th} bypass network, and an output representation of a T^{th} denoising network is a denoised latent space representation.

The denoising network of the diffusion model and the bypass network of the bypass module successively denoise latent space features based on the character representation, so that a finally obtained denoised latent space representation can fully meet a constraint of the character representation, and a predicted image generated by the image generation model may be as close as possible to a character image corresponding to the character representation.

In conclusion, the foregoing denoising process is described in detail as follows. In a denoising process of the image generation model provided in the embodiments of the present disclosure, the backward processing module of the diffusion model and the bypass module are needed to jointly complete the task of denoising for T times. The backward processing module of the diffusion model includes T denoising networks, and the bypass module includes T bypass networks, and the i^{th} denoising network being in one-to-one correspondence with the i^{th} bypass network. Each denoising network includes an upsampling network and a downsampling network. Each bypass network includes a downsampling network. The upsampling network, the downsampling network, and the bypass network in the embodiments of the present disclosure are all neural networks. Specific structures of the upsampling network, the downsampling network, and the bypass network in the denoising network are not limited in the present disclosure. Exemplarily, the upsampling network and the downsampling network in the denoising network are pre-training models, and the parameter of the bypass network is initialized through a parameter of the downsampling network of the denoising network in the pre-training model. Exemplarily, the downsampling network of the ^{ith} denoising network includes N cascaded second network units. Exemplarily, the upsampling network of the i^{th} denoising network also includes N cascaded second network units. Exemplarily, the downsampling network included in the i^{th} bypass network is N cascaded first network units. Exemplarily, the first network unit and the second network unit are both QKV units.

Exemplarily, in a first denoising process, a character representation and the latent space representation are respectively inputted into a first bypass network and a downsampling network of a first denoising network, to obtain output data of the first bypass network and output data of a downsampling network of the first denoising network. Input data of an upsampling network of the first denoising network is obtained based on the output data of the first bypass network and the output data of the downsampling network of the first denoising network. The character representation and the input data of the upsampling network of the first denoising network are inputted into the upsampling network of the first denoising network, to obtain a first output representation. In an i^{th} denoising process, the character representation and an (i−1)^{th} output representation are respectively inputted into an i^{th} bypass network and the downsampling network of the i^{th} denoising network, to obtain output data of the i^{th} bypass network and output data of the downsampling network of the i^{th} denoising network. The character representation and the input data of the upsampling network of the i^{th} denoising network are inputted into the upsampling network of the i^{th} denoising network, to obtain an i^{th} output representation. A T^{th} output representation is determined as a denoised latent space representation.

Exemplarily, weighted summation is performed on output data of a j^{th} first network unit included in the i^{th} bypass network and output data of a j^{th} second network unit included in the downsampling network of the i^{th} denoising network, and then a result of the weighted summation is used as input data of a (j+1)^{th} second network unit included in the downsampling network of the i^{th} denoising network, j being a positive integer less than N. The input data of the (j+1)^{th} second network unit included in the downsampling network of the i^{th} denoising network is passed through the (j+1)^{th} second network unit included in the downsampling network of the i^{th} denoising network, to obtain output data of the (j+1)^{th} second network unit included in the downsampling network of the i^{th} denoising network, and output data of an N^{th} second network unit included in the downsampling network of the i^{th} denoising network is used as the output data of the downsampling network of the i^{th} denoising network.

Operation 350: Decode the denoised latent space representation through a first decoder, to generate a predicted image corresponding to the character name.

The first decoder refers to any decoder. The first decoder decodes the denoised latent space representation, to obtain an image corresponding to the denoised latent space representation.

Operation 360: Adjust parameters of the representation extraction module and the bypass module based on a difference between the predicted image and the character image, to obtain a trained image generation model.

Operation 360 includes at least one sub-operation of operations 360-I and 360-II, for example.

Operation 360-I: Calculate a loss function value based on the difference between the predicted image and the character image.

In some embodiments, the loss function value is determined based on a difference between pixel values of pixels at corresponding positions between the predicted image and the character image. Exemplarily, the difference between the predicted image and the character image may be calculated through a mean squared error (MSE) loss, and the loss function value may be expressed as the following equation.

$$M SE = {\sum }_{i = 1}^{n} {( {y}_{i} - {y}_{i}^{p} )}^{2}$$

where y represents a pixel value of each point in an image, yᵢ represents a pixel value of each point in a character image in an image-text pair,

$${y}_{i}^{p}$$

represents a pixel value of each point in the predicted image, and n represents a quantity of pixels in the image. Certainly, in addition to the MSE, the difference between the pixel values of the pixels at the corresponding positions between the predicted image and the character image may further be calculated through a variance, a standard deviation, and the like. A specific type of the loss function value is not limited in the present disclosure.

In some embodiments, if the training sample set is divided into a plurality of batches for training, a loss of each batch of samples may be calculated, and a sum of losses of the plurality of batches is used as a loss function value of the iterative round.

Operation 360-II: Perform a plurality of rounds of iterative adjustment on the parameters of the representation extraction module and the bypass module based on the loss function value, to obtain a trained image generation model, each round of iterative adjustment being configured for adjusting the parameter of one of the representation extraction module and the bypass module, a parameter of the other module remaining unchanged, and the parameters of the representation extraction module and the bypass module being adjusted alternately.

A parameter of one of the representation extraction module and the bypass module is first adjusted based on the loss function value, a parameter of the other module remains unchanged, and then the parameter of the other of the representation extraction module and the bypass module is adjusted. The parameter of a previously adjusted module remains unchanged, and then the representation extraction module and the bypass module are respectively adjusted in sequence in an order of alternating adjustment. After the loss function value satisfies a training condition, the trained image generation model may be obtained. For example, the parameter of the representation extraction module may be adjusted first based on the loss function value, and the parameter of the bypass module remains unchanged. Then, the parameter of the bypass module is adjusted, and the parameter of the representation extraction module remains unchanged. Then, the parameter of the representation extraction module continues to be adjusted, and the adjustment is alternately performed in turns. After the loss function value satisfies the training condition, the parameter adjustment is stopped, to obtain the trained image generation model.

In some embodiments, the training condition of the loss function value may be that the loss function value is less than a set threshold, or may be that the loss function value is within a set threshold range, and so on. This is not limited in the present disclosure.

Convergence speeds of the representation extraction module and the bypass module are different, which may mean that the convergence speed of the representation extraction module is greater than the convergence speed of the bypass module, or may mean that the convergence speed of the bypass module is greater than the convergence speed of the representation extraction module. Since the convergence speeds of the representation extraction module and the bypass module are different, a module with a faster convergence speed in the representation extraction module and the bypass module first completes convergence. In this case, the module that first completes convergence no longer participates in a subsequent convergence process, and a module that does not complete convergence continues to perform convergence.

For example, when the convergence speed of the representation extraction module is greater than the convergence speed of the bypass module, the representation extraction module first completes convergence after a plurality of iterative adjustments. In this case, the bypass module has not completed convergence yet. Therefore, parameter adjustment is no longer performed on the representation extraction module subsequently, and the parameter adjustment is performed on the bypass module in each iteration.

In some embodiments, the loss is fed back into the image generation model through stochastic gradient descent (SGD), to obtain gradients of representation extraction module and the bypass module, and update the parameters accordingly.

The parameters of the representation extraction module and the bypass module are alternately adjusted, so that the two modules can learn sufficient information, thereby achieving a better image generation effect, and avoiding a problem of overfitting of an overall model easily caused by continuous training of a single module.

Through the technical solutions provided in the embodiments of the present disclosure, when a predicted image corresponding to a character name is generated, a latent space representation is denoised for T times through a character representation, and the denoised latent space representation is further decoded to obtain the predicted image corresponding to the character name, so that the generation effect of the predicted image can be improved.

Further, in a downsampling network (an encoding network) in each denoising process, the character representation and the i^{th} input representation are considered comprehensively. In an upsampling network (a decoding network) in each denoising process, output data of the downsampling network and output data of the bypass network are considered comprehensively. Therefore, the character representation is fused in the downsampling network and the upsampling network in each noise addition process, so that a proportion of the character representation in an image prediction process can be increased, thereby improving a prediction effect.

In addition, input data of a (j+1)^{th} second network unit included in the bypass network is determined by performing weighted summation on output data of a j^{th} first network unit included in the bypass network and output data of a j^{th} second network unit included in a downsampling network in an i^{th} denoising network. A relationship between the bypass network and the denoising network is balanced by setting a weight. In other words, a degree of intervention of the bypass network in a denoising process is determined by setting a weight. This helps improve flexibility of the denoising process.

Finally, the parameter of the downsampling network (encoding) of the denoising network in the pre-trained denoising model is directly used as the initialization parameter of the bypass network, which helps reduce training costs and improve training efficiency.

FIG. 6 is a schematic structural diagram showing an image generation model. A random noise image X corresponding to a random number is obtained based on any random number, the random noise image X is encoded through an encoder, to obtain an initial feature vector Z of the random noise image, and noise addition is performed on the initial feature vector for T times through a forward processing module of a diffusion model, to generate a latent space representation Z_{T} corresponding to the random noise image. The latent space representation Z_{T} and the character representation are respectively used as input data of the downsampling network of the denoising network and a bypass network, input data of the upsampling network is obtained based on output data of the bypass network and the downsampling network, and the upsampling network obtains a denoised output feature Z_{T-1′} based on the input data of the character representation and the upsampling network. Then, a denoised latent space representation Z′ is obtained through actions of the denoising network and the bypass network for T−1 times. The denoised latent space representation Z′ is decoded through a decoder, to generate a predicted image Y corresponding to the character name.

A character name corresponding to an original character image is obtained based on the original character image, so that the representation extraction module generates, based on the character name, a character representation corresponding to the character name, as input data of the denoising network and the bypass network. Enhancement processing is performed on the original character image to improve image quality, to obtain a character image corresponding to the character name, thereby calculating the loss function value based on the difference between the character image and the predicted image. The parameters of the representation extraction module and the bypass module are alternately adjusted based on the loss function value. After the loss function value satisfies the training condition, the trained image generation model may be obtained.

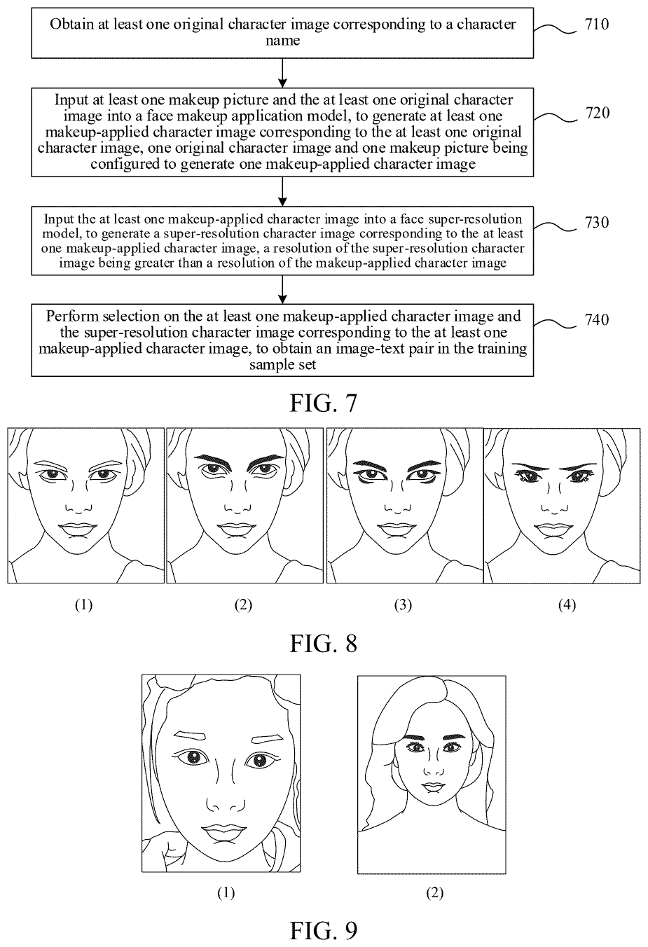

FIG. 7 is a flowchart of a method for generating a training sample set of an image generation model according to an embodiment of the present disclosure. Each operation of the method may be performed by a computer device. The method may include at least one of the following operations 710-740.

Operation 710: Obtain at least one original character image corresponding to a character name.

The original character image is a character image that is not subjected to image enhancement processing, for example, may include a character image that is not subjected to color adjustment, restoration, and optimization processing. In some embodiments, the original character image may be a low-quality image, for example, an image with a relatively low resolution, or may be a high-quality image, for example, an image with a relatively high resolution.

Operation 720: Input at least one makeup picture and the at least one original character image into a face makeup application model, to generate at least one makeup-applied character image corresponding to the at least one original character image, one original character image and one makeup picture being configured to generate a makeup-applied character image.

A makeup picture refers to a reference character image having a reference makeup, and a makeup-applied character image refers to a character image of an original character image with a reference makeup of a makeup picture. The face makeup application model is configured to fuse the original character image with the reference makeup in the makeup picture, to generate a makeup-applied character image with the reference makeup.

Input data of the face makeup application model includes an original character image and a makeup picture, and output data is a makeup-applied character image that is a fusion of the original character image and the reference makeup. One makeup picture may be configured for generating a makeup-applied character image corresponding to one original character image.

In some embodiments, an input of the face makeup application model includes a face image and a makeup picture, and an output is a makeup-applied character image obtained after makeup is applied to the face image. In some embodiments, an input of the face makeup application model includes an original character image and a makeup picture, and an output is a makeup-applied character image corresponding to the original character image. In other words, the face makeup application model is a model configured for performing face makeup application. In some embodiments, the face makeup application model is a trained ML model.

In some embodiments, at least one makeup picture includes at least one of the following: a makeup picture with a strong makeup application effect; and a makeup picture with a natural makeup application effect.

For the makeup picture with a strong makeup application effect, reference may be made to FIG. 8, (1) of FIG. 8 being an original character image, and (2), (3), and (4) of FIG. 8 being respectively makeup-applied character images generated based on different makeup pictures. The strong makeup application effect refers to a makeup application effect that with a relatively abundant makeup and a relatively strong makeup effect and that affects a character image style. For example, in (2) of FIG. 8, the makeup application effect makes the character look sharper.

For the makeup picture with a natural makeup application effect, reference may be made to FIG. 9, (1) of FIG. 9 being an original character image, and (2) of FIG. 9 being a makeup-applied character image generated based on a makeup picture. The natural makeup application effect is a makeup application effect that only modifies facial defects of a character without changing a character image style.

Operation 730: Input the at least one makeup-applied character image into a face super-resolution model, to generate a super-resolution character image corresponding to the at least one makeup-applied character image, a resolution of the super-resolution character image being greater than a resolution of the makeup-applied character image.

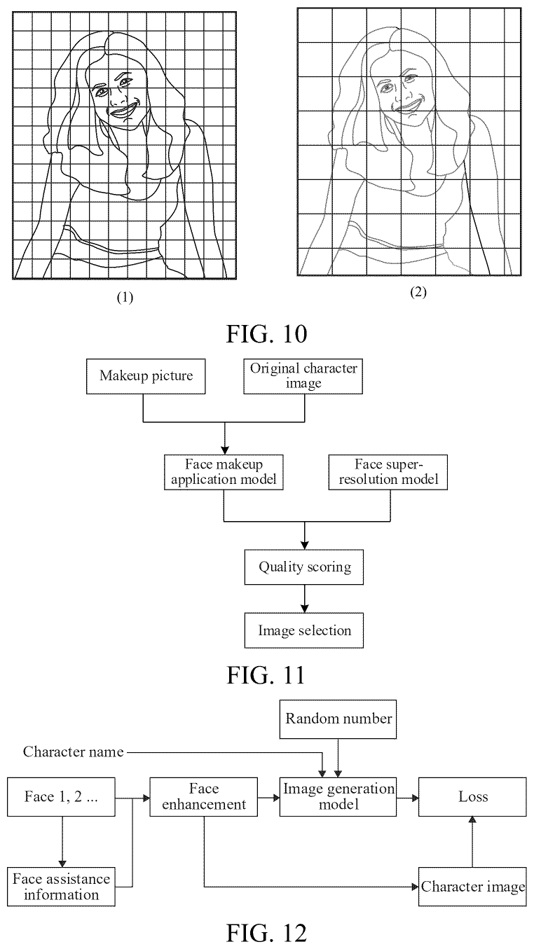

The face super-resolution model is configured to optimize the makeup-applied character image, so that a resolution of a generated super-resolution character image is greater than a resolution of the makeup-applied character image. For an optimization effect of the face super-resolution model, reference may be made to FIG. 10, (1) of FIG. 10 being a super-resolution character image, (2) of FIG. 10 being a makeup-applied character image, and small grids representing pixels of an image. It may be apparently seen that a resolution of (1) of FIG. 10 is greater than a resolution of (2) of FIG. 10.

In some embodiments, an input of the face super-resolution model is an image, and an output is a super-resolution image after the resolution is increased. In other words, the face super-resolution model is a model configured to increase a resolution of an inputted image. Specifically, an input of the face super-resolution model is a makeup-applied character image, and an output is a super-resolution character image. In some embodiments, the face super-resolution model is a trained ML model.

Operation 740: Perform selection on the at least one makeup-applied character image and the super-resolution character image corresponding to the at least one makeup-applied character image, to obtain an image-text pair in the training sample set.

In some embodiments, selection may be performed on the at least one makeup-applied character image and the super-resolution character image corresponding to the at least one makeup-applied character image, to obtain an image-text pair in the training sample set, or selection may be performed on the super-resolution character image corresponding to the at least one makeup-applied character image, to obtain an image-text pair in the training sample set. This is not limited in the present disclosure.

In the embodiments of the present disclosure, selection is performed on the at least one makeup-applied character image and the super-resolution character image corresponding to the at least one makeup-applied character image, and operation 740 includes at least one sub-operation of operations 740-I, 740-II, and 740-III, for example.

Operation 740-I: Perform quality scoring on each character image in the at least one makeup-applied character image and the super-resolution character image corresponding to the at least one makeup-applied character image, to obtain a score corresponding to each character image.

A score corresponding to each character image is configured for measuring an aesthetic degree of each character image. The aesthetic degree of the character image includes image elements such as a resolution of the character image, a degree of fit between a character makeup and the character image, and an aesthetic degree of the character makeup.

Operation 740-II: Select, from each character image, at least one character image whose score satisfies a condition as at least one character image having a matching relationship with the character name.

At least one character image whose score satisfies a condition is selected, based on the score of each character image, as the at least one character image that has a matching relationship with the character name. A condition for satisfying the score may be that a score of the character image is greater than a set threshold, or may be that the score of the character image is within a proportion threshold of all character images. For example, the condition for satisfying the score may be first 10% character images of all the character images.

Quality of the character image whose score satisfies the condition is significantly higher than quality of the original character image on which no image enhancement processing is performed. A high-quality character image is used as the at least one character image that has the matching relationship with the character name.

FIG. 11 is a schematic diagram showing an image enhancement processing process. A face makeup application model generates a makeup-applied character image through an original character image and a makeup picture, and a face super-resolution model generates a super-resolution character image corresponding to the makeup-applied character image, and performs quality scoring on the makeup-applied character image and the super-resolution character image, so that at least one character image that has a matching relationship with a character name may be selected based on a score corresponding to each character image.

Operation 740-III: Obtain at least one image-text pair in a training sample set based on the character name and the at least one character image having a matching relationship with the character name.

A character name is combined with a character image that has a matching relationship with the character name, to obtain an image-text pair. A character name is combined with at least one character image that has a matching relationship with the character name, to obtain at least one image-text pair corresponding to a character name. Therefore, at least one image-text pair in the training sample set may be obtained based on a different character name and at least one character image that has a matching relationship with the character name.

FIG. 12 is a schematic diagram showing an effect of an image enhancement processing process on an image generation model. Face assistance information is extracted from each face. A face makeup application model and a face super-resolution model perform face enhancement based on the face assistance information, to obtain a character image after face enhancement. The character image is configured to be compared with a prediction model generated by the image generation model, to calculate a loss function value based on a difference between the character image and the prediction model, so as to alternately adjust parameters of a representation extraction module and a bypass module of the image generation model.

Quality scoring is performed on a makeup-applied character image and a super-resolution character image, and a character image that satisfies a condition is selected based on each score as the at least one character image that has the matching relationship with the character name, to screen out a character image with a relatively low image aesthetic degree, so that finally retained character images are character images with relatively high quality, which is helpful for the model to perform parameter adjustment based on a high-quality image, thereby improving the image generation effect of the model.

Through the technical solutions provided in the embodiments of the present disclosure, enhancement processing is performed on an original character image, non-key face information in the original character image is excluded, and effective extraction of key face information in the original character image is ensured, thereby obtaining a high-quality character image including the key face information, avoiding a problem of overfitting as a result of performing training by an image generation model based on the non-key face information in the original character image, and improving an image generation effect of the image generation model.

Certainly, in the embodiments of the present disclosure, when the image-text pair in the training sample set is obtained, the makeup-applied character image is directly obtained through the face makeup application model, which helps improve a speed of obtaining the training sample set.

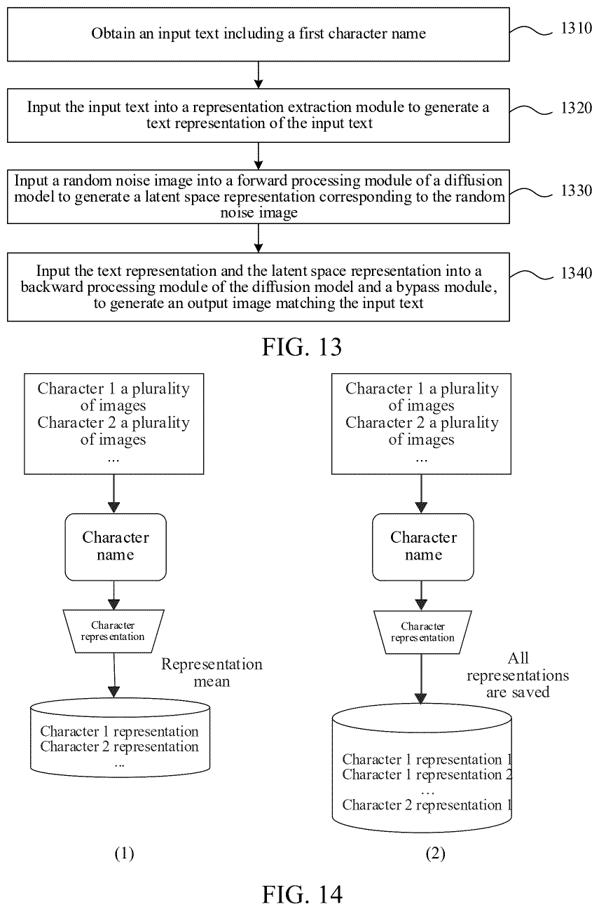

FIG. 13 is a flowchart showing an image generation method based on an image generation model according to an embodiment of the present disclosure. The image generation model is trained through the foregoing method, and the image generation model includes a representation extraction module, a bypass module, and a diffusion model. Each operation of the method may be performed by a computer device. The method may include at least one of the following operations 1310-1340.

Operation 1310: Obtain an input text including a first character name.

The first character name is any character name, and the input text includes the first character name. For example, the input text may be “Zhang XX with red lips is looking in a mirror”, “Zhang XX” being a first character name.

Operation 1320: Input the input text into the representation extraction module to generate a text representation of the input text.

The text representation is configured for representing text information of the input text.

Operation 1320 includes at least one sub-operation of operations 1320-I, 1320-II, and 1320-III, for example.

Operation 1320-I: Input the input text into the representation extraction module to generate an original text representation of the input text, the original text representation including an original character representation corresponding to the first character name.

The original text representation refers to a text representation directly obtained by the representation extraction module based on the input text. The original text representation includes an original character representation corresponding to the first character name. The original character representation refers to a character representation corresponding to the first character name obtained by the representation extraction module based on the first character name in the input text.

Operation 1320-II: Obtain a character representation corresponding to the first character name from a character representation library, the character representation library having character representations respectively corresponding to different character names stored therein.

The character representation stored in the character representation library may be the same as or different from the character representation obtained by the representation extraction module based on the first character name. Usually, compared with the character representation obtained by the representation extraction module based on the first character name, the character representation stored in the character representation library can more accurately represent character feature information corresponding to the first character name.

In some embodiments, in the character representation library, each character name corresponds to one character representation, and the character representation corresponding to the character name is a mean value of a plurality of character representations obtained based on a plurality of character images corresponding to the character name.

One character name may correspond to a plurality of character images, one character image corresponds to one character representation, and character features to be represented by each character image are different, which may include a character image representing a happy mood of the character, a character image representing a sentimental emotion of the character, an image representing a gloomy mood of the character, or the like. A mean value of a plurality of character representations of the plurality of character images corresponding to the character name is calculated to obtain a representation mean corresponding to the character name, and the representation mean is stored into the character representation library as a character representation of the character name.

The representation mean is configured for representing an average character feature of a plurality of character images, namely, a representation mean of character representations fused with a plurality of character images. For example, a representation mean of a character name may represent a character image without any emotion.

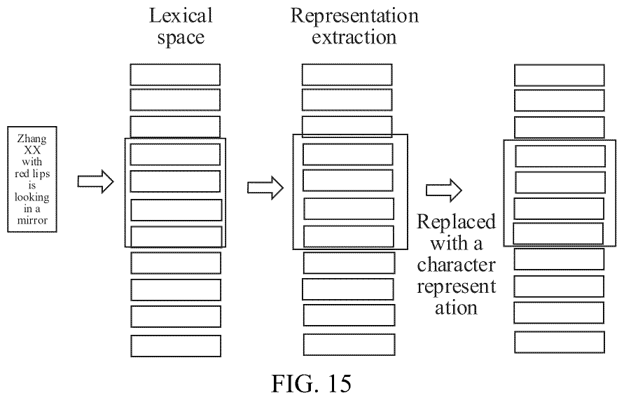

For a process of generating the character representation library based on a mean of a plurality of character representations obtained based on the plurality of character images, reference may be made to (1) of FIG. 14. After training of the image generation model is completed, for a character name, a mean of the plurality of character representations is calculated based on the plurality of character representations corresponding to the plurality of character images, and the representation mean is stored into the character representation library, so that the character representation library may include character representations respectively corresponding to different character names, for example, a character 1 representation and a character 2 representation shown in (1) of FIG. 14.

A mean of a plurality of character representations obtained from a plurality of character images corresponding to the character name is used as the character representation corresponding to the character name, so that the character name may be represented more comprehensively, and the generated character image can adapt to more general application requirements.

In some embodiments, in the character representation library, each character name corresponds to a plurality of character representations, and one character representation corresponding to the character name is obtained based on one character image corresponding to the character name.

One character name corresponds to a plurality of character images, one character image corresponds to one character representation, one character name corresponds to a plurality of character representations, and the plurality of character representations corresponding to each character name are stored into the character representation library.

For a process of generating the character representation library based on a plurality of character representations obtained from the plurality of character images, reference may be made to (2) of FIG. 14. After training of the image generation model is completed, for a character name, a plurality of character representations corresponding to the character name are stored into the character representation library, so that the character representation library may include a plurality of character representations respectively corresponding to different character names, for example, a character 1 representation 1, a character 1 representation 2, . . . , a character 2 representation 1, and a character 2 representation 2 shown in (2) of FIG. 14.

In some embodiments, a plurality of character representations corresponding to the first character name are obtained from the character representation library, a similarity between each of the plurality of character representations and an original character representation corresponding to the first character name is calculated, and a character representation with a highest similarity is selected from the plurality of character representations as the character representation corresponding to the first character name.

Through calculation of the similarity between each of the plurality of character representations and the original character representation corresponding to the first character name, a matching degree between each of the plurality of character representations and the input text may be obtained, so that the character representation with the highest similarity is selected from the plurality of character representations as the character representation corresponding to the first character name. In this way, the selected character representation can be more consistent with a meaning to be expressed by the input text, and a character image generated by the image generation model can also better match the input text, thereby satisfying more diversified image generation requirements.

If the input text is “Zhang XX with red lips is looking in the mirror”, a character representation with a highest matching degree with the input text needs to be selected from a plurality of character representations. For example, a character representation with the highest similarity degree may be a character representation that represents a sexy style of the character, which may be more consistent with a semantic feature of “Zhang XX with red lips is looking in the mirror”. If the selected character representation is a character representation representing a youthful style of a character, the generated character image is difficult to match the input text.

Operation 1320-III: Replace the original character representation corresponding to the first character name in the original text representation with the character representation corresponding to the first character name, to generate the text representation of the input text.

After the character representation corresponding to the first character name is determined, the original character representation corresponding to the first character name in the original text representation is replaced with the character representation corresponding to the first character name, to generate the text representation of the input text. The text representation of the input text is used as input data of a diffusion model.

For a process of replacing an original character representation with the representation mean as the character representation of the character name, reference may be made to FIG. 15. An input text is “Zhang XX with red lips is looking in the mirror”. The input text is mapped to a lexical space to obtain an original text representation corresponding to “Zhang XX with red lips is looking in the mirror”. An original text representation selected with a box is an original character representation corresponding to “Zhang XX with red lips is looking in the mirror”. A representation mean corresponding to “Zhang XX” in the character representation library is obtained, and the original character representation in the original text representation is replaced to obtain a text representation corresponding to “Zhang XX with red lips is looking in the mirror”.

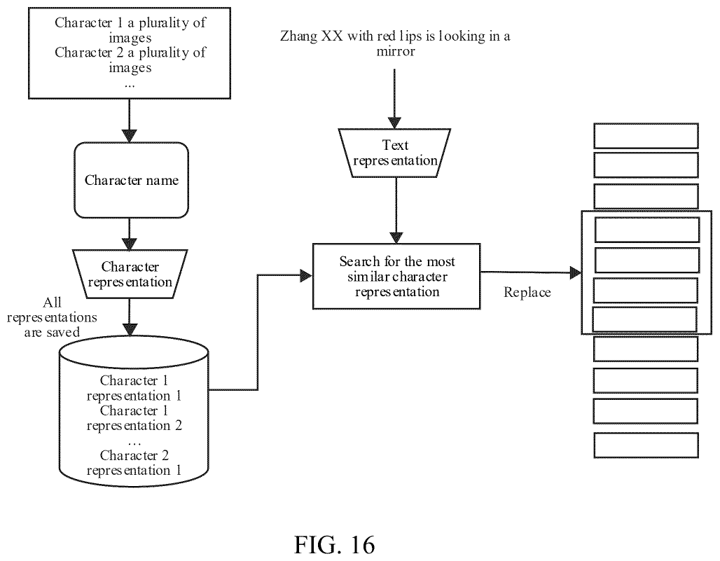

For a process of replacing the original character representation with a character representation with the highest similarity with the original character representation in the plurality of character representations, reference may be made to FIG. 16. A character representation library stores a plurality of character representations corresponding to different character names. For example, a character 1 corresponds to a character 1 representation 1, a character 1 representation 2, and so on. In this case, when an original character representation corresponding to “Zhang XX” in the input text “Zhang XX with red lips is looking in the mirror” is replaced, a similarity between each of a plurality of character representations corresponding to “Zhang XX” and the original character representation corresponding to “Zhang XX” needs to be calculated, to search for a character representation with a highest similarity, and the character representation with the highest similarity is replaced with the original character representation corresponding to “Zhang XX”, to obtain a text representation corresponding to “Zhang XX with red lips is looking in the mirror”.

Operation 1330: Input a random noise image into a forward processing module of a diffusion model to generate a latent space representation corresponding to the random noise image.

Operation 1340: Input the text representation and the latent space representation into a backward processing module of the diffusion model and the bypass module, to generate an output image matching the input text.

In some embodiments, the text representation and the latent space representation are inputted into the backward processing module of the diffusion model and the bypass module, and the latent space representation is denoised for T times based on the text representation through the backward processing module of the diffusion model and the bypass module, to obtain a denoised latent space representation, T being a positive integer. The denoised latent space representation is decoded through a first decoder, to generate an output image that matches the input text.

In some embodiments, the backward processing module of the diffusion model includes T denoising networks, the denoising networks including a downsampling network and an upsampling network, and the bypass module including T bypass networks.

In some embodiments, in an i^{th} denoising process, the text representation and an i^{th} input representation are respectively inputted into an i^{th} bypass network and a downsampling network of an i^{th} denoising network, to obtain output data of the i^{th} bypass network and output data of the downsampling network of the i^{th} denoising network. Input data of an upsampling network of the i^{th} denoising network is obtained based on the output data of the i^{th} bypass network and the output data of the downsampling network of the i^{th} denoising network. The text representation and the input data of the upsampling network of the i^{th} denoising network are inputted into the upsampling network of the i^{th} denoising network, to obtain an i^{th} output representation, i being a positive integer less than or equal to T, a first input representation being the latent space representation, the i^{th} output representation being used as an (i+1)^{th} input representation, and a T^{th} output representation being the denoised latent space representation.

In some embodiments, the i^{th} bypass network and the downsampling network of the i^{th} denoising network have the same structure, the i^{th} bypass network including N cascaded first network units, and the downsampling network of the i^{th} denoising network including N cascaded second network units, N being an integer greater than 1.

In some embodiments, weighted summation is performed on output data of a j^{th} first network unit included in the i^{th} bypass network and output data of a j^{th} second network unit included in the downsampling network of the i^{th} denoising network, and then a result of the weighted summation is used as input data of a (j+1)^{th} second network unit, j being a positive integer less than N.

For function introduction of the diffusion model in the foregoing operation 1330 and operation 1340, reference may be made to the foregoing embodiments, and details are not described herein again.

Through the technical solutions provided in the embodiments of the present disclosure, the representation extraction module generates the text representation of the input text, so that the generated text representation may represent feature information of the input text in a diversified manner, thereby improving functional diversity of the image generation model. The character name can be represented more comprehensively through a representation mean, so that a generated character image can adapt to more general application requirements, and the input text can be represented in a targeted manner by selecting a character representation with a highest similarity with an original character representation, so that the generated character image can match the input text more closely, thereby satisfying more diversified image generation requirements. In addition, the bypass module is introduced in the denoising process, which helps improve a denoising effect, and further improves an image generation effect.

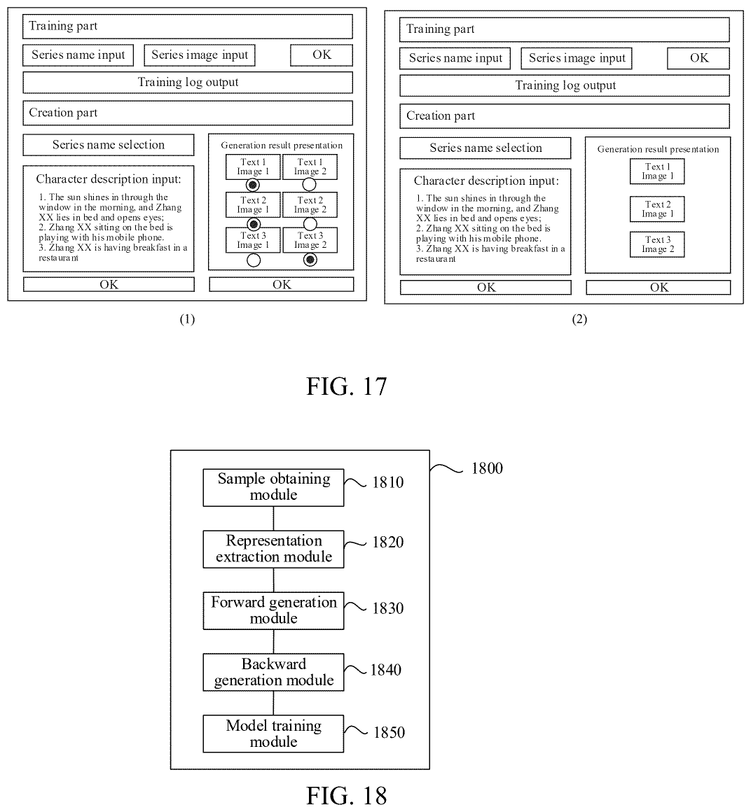

FIG. 17 is a schematic diagram showing an application interface of an image generation model, (1) of FIG. 17 representing a display interface of a training process of a newly added training task of the image generation model, and (2) of FIG. 17 representing a display interface for final presentation of a training result of the image generation model.

The training part in (1) of FIG. 17 may support training of a newly added character name. A newly added training sample is inputted into the “series name input” and the “series image input part”, and an application program generates a training log and a training result by clicking/tapping the “OK” button. Creation of a trained character name is also supported in (1) of FIG. 17. The character name may be inputted into the “series name selection” in the creation part. A plurality of lines of text descriptions about the character name are inputted into a “character description” box, and an “OK” button below the “character description” box is clicked/tapped. A corresponding character image is displayed in a “generation result presentation” box, and a plurality of character images may be generated for each text description in the presentation box. The user may click/tap a preferred character image, click/tap the “OK” button below the “generation result presentation” box, and then jump to a display interface shown in (2) of FIG. 17. A finally selected character image is presented in the “generation result presentation” box on the display interface in (2) of FIG. 17.

The training method for an image generation model and the image generation method based on an image generation model provided in the embodiments of the present disclosure are corresponding model training processes and usage processes. For details that are not described in detail on one side, reference may be made to descriptions on the other side.

An apparatus embodiment of the present disclosure is described below, which may be configured for performing the method embodiment of the present disclosure. For details not disclosed in the apparatus embodiment of the present disclosure, reference is made to the method embodiments of the present disclosure.

FIG. 18 is a block diagram showing a training apparatus for an image generation model according to an embodiment of the present disclosure. The image generation model includes a representation extraction module, a bypass module, and a pre-trained diffusion model. As shown in FIG. 18, the apparatus 1800 may include: a sample obtaining module 1810, a representation extraction module 1820, a forward generation module 1830, a backward generation module 1840, and a model training module 1850.

The sample obtaining module 1810 is configured to obtain a training sample set of the image generation model, the training sample set including at least one image-text pair, and each image-text pair including a character name and a character image that have a matching relationship.

The representation extraction module 1820 is configured to input the character name in the image-text pair into the representation extraction module to generate a character representation corresponding to the character name.

The forward generation module 1830 is configured to input a random noise image into a forward processing module of the diffusion model to generate a latent space representation corresponding to the random noise image.

The backward generation module 1840 is configured to input the character representation and the latent space representation into a backward processing module of the diffusion model and the bypass module, to generate a predicted image corresponding to the character name.

The model training module 1850 is configured to adjust parameters of the representation extraction module and the bypass module based on a difference between the predicted image and the character image, to obtain a trained image generation model.

In some embodiments, the backward generation module 1840 includes a denoising unit and a decoding unit.

The denoising unit is configured to input the character representation and the latent space representation into the backward processing module of the diffusion model and the bypass module, and denoise the latent space representation for T times based on the character representation through the backward processing module of the diffusion model and the bypass module, to obtain a denoised latent space representation, T being a positive integer.

The decoding unit is configured to decode the denoised latent space representation through a first decoder, to generate a predicted image corresponding to the character name.

In some embodiments, the backward processing module of the diffusion model includes T denoising networks, the denoising networks including a downsampling network and an upsampling network, and the bypass module including T bypass networks.

The denoising unit is configured to: respectively input, in an i^{th} denoising process, the character representation and an i^{th} input representation into an i^{th} bypass network and a downsampling network of an i^{th} denoising network, to obtain output data of the i^{th} bypass network and output data of the downsampling network of the i^{th} denoising network; obtain input data of an upsampling network of the i^{th} denoising network based on the output data of the i^{th} bypass network and the output data of the downsampling network of the i^{th} denoising network; and input the character representation and the input data of the upsampling network of the i^{th} denoising network into the upsampling network of the i^{th} denoising network, to obtain an i^{th} output representation, i being a positive integer less than or equal to T, a first input representation being the latent space representation, the i^{th} output representation being used as an (i+1)^{th} input representation, and a T^{th} output representation being the denoised latent space representation.

In some embodiments, the i^{th} bypass network and the downsampling network of the i^{th} denoising network have a same structure, the i^{th} bypass network including N cascaded first network units, and the downsampling network of the i^{th} denoising network including N cascaded second network units, N being an integer greater than 1. Weighted summation is performed on output data of a j^{th} first network unit included in the i^{th} bypass network and output data of a j^{th} second network unit included in the downsampling network of the i^{th} denoising network, and then a result of the weighted summation is used as input data of a (j+1)^{th} second network unit, j being a positive integer less than N.

In some embodiments, the apparatus 1800 further includes an initialization module.

The initialization module is configured to use a parameter of the downsampling network of the i^{th} denoising network as an initialized parameter of the i^{th} bypass network.

In some embodiments, the sample obtaining module 1810 includes an original image obtaining unit, a makeup-applied image generation unit, and a selection unit.

The original image obtaining unit is configured to obtain at least one original character image corresponding to the character name.

The makeup-applied image generation unit is configured to input at least one makeup picture and the at least one original character image into a face makeup application model, to generate at least one makeup-applied character image corresponding to the at least one original character image, one original character image and one makeup picture being configured to generate a makeup-applied character image.

The selection unit is configured to perform selection on the at least one makeup-applied character image to obtain an image-text pair in the training sample set.

In some embodiments, the sample obtaining module 1810 further includes a super-resolution image generation unit.

The super-resolution image generation unit is configured to input the at least one makeup-applied character image into a face super-resolution model, to generate a super-resolution character image corresponding to the at least one makeup-applied character image, a resolution of the super-resolution character image being greater than a resolution of the makeup-applied character image.

The selection unit is configured to perform selection on the at least one makeup-applied character image and the super-resolution character image corresponding to the at least one makeup-applied character image, to obtain the image-text pair in the training sample set.

In some embodiments, the selection unit is configured to: perform quality scoring on each character image in the at least one makeup-applied character image and the super-resolution character image corresponding to the at least one makeup-applied character image, to obtain a score corresponding to each character image; select, from each character image, at least one character image whose score satisfies a condition as at least one character image having a matching relationship with the character name; and obtain at least one image-text pair in the training sample set based on the character name and the at least one character image having a matching relationship with the character name.

In some embodiments, the model training module 1850 is configured to calculate a loss function value based on the difference between the predicted image and the character image; and perform a plurality of rounds of iterative adjustment on the parameters of the representation extraction module and the bypass module based on the loss function value, to obtain the trained image generation model, each round of iterative adjustment being configured for adjusting the parameter of one of the representation extraction module and the bypass module, a parameter of the other module remaining unchanged, and the parameters of the representation extraction module and the bypass module being adjusted alternately.

In the technical solutions provided in the embodiments of the present disclosure, on the one hand, the bypass module is added to the image generation model, so that during iterative training of the image generation model, only the representation extraction module and the bypass module may be trained, and the diffusion model does not need to be trained, to avoid a problem of model overfitting caused by the diffusion model forgetting a trained parameter as a result of training the pre-trained diffusion model again, thereby improving quality of an image generated by the model. On the other hand, the used training sample set includes a plurality of character images corresponding to a same character name, so that the trained image generation model may generate different character representations of the same character name, thereby meeting different character image generation requirements and improving functional diversity of the image generation model.

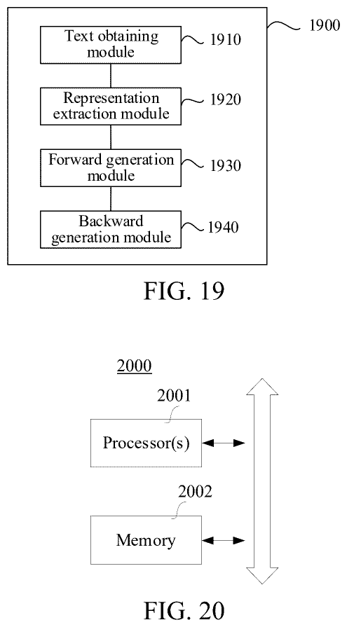

FIG. 19 is a block diagram showing an image generation apparatus based on an image generation model according to an embodiment of the present disclosure. The image generation model includes a representation extraction module, a bypass module, and a diffusion model. As shown in FIG. 19, the apparatus 1900 may include a text obtaining module 1910, a representation extraction module 1920, a forward generation module 1930, and a backward generation module 1940.

The text obtaining module 1910 is configured to obtain an input text including a first character name.

The representation extraction module 1920 is configured to input the input text into the representation extraction module to generate a text representation of the input text.

The forward generation module 1930 is configured to input a random noise image into a forward processing module of the diffusion model to generate a latent space representation corresponding to the random noise image.

The backward generation module 1940 is configured to input the text representation and the latent space representation into a backward processing module of the diffusion model and the bypass module, to generate an output image matching the input text.

In some embodiments, the representation extraction module 1920 includes an original representation extraction unit, a character representation obtaining unit, and a replacement unit.

The original representation extraction unit is configured to generate an original text representation of the input text through the representation extraction module, the original text representation including an original character representation corresponding to the first character name.

The character representation obtaining unit is configured to obtain a character representation corresponding to the first character name from a character representation library, the character representation library having character representations respectively corresponding to different character names stored therein.

The replacement unit is configured to replace the original character representation corresponding to the first character name in the original text representation with the character representation corresponding to the first character name, to generate the text representation of the input text.

In some embodiments, in the character representation library, each character name corresponds to one character representation, and the character representation corresponding to the character name is a mean value of a plurality of character representations obtained based on a plurality of character images corresponding to the character name.

In some embodiments, in the character representation library, each character name corresponds to a plurality of character representations, and one character representation corresponding to the character name is obtained based on one character image corresponding to the character name.

The character representation obtaining unit is configured to obtain a plurality of character representations corresponding to the first character name from the character representation library; calculate a similarity between each of the plurality of character representations and an original character representation corresponding to the first character name; and select, from the plurality of character representations, a character representation with a highest similarity as the character representation corresponding to the first character name.

In some embodiments, the backward generation module 1940 includes a denoising unit and a decoding unit.

The denoising unit is configured to input the text representation and the latent space representation into the backward processing module of the diffusion model and the bypass module, and denoise the latent space representation for T times based on the text representation through the backward processing module of the diffusion model and the bypass module, to obtain a denoised latent space representation, T being a positive integer.

The decoding unit is configured to decode the denoised latent space representation through a first decoder, to generate an output image that matches the input text.

In some embodiments, the backward processing module of the diffusion model includes T denoising networks, the denoising networks including a downsampling network and an upsampling network, and the bypass module including T bypass networks.

The denoising unit is configured to: respectively input, in an i^{th} denoising process, the text representation and an i^{th} input representation into an i^{th} bypass network and a downsampling network of an i^{th} denoising network, to obtain output data of the i^{th} bypass network and output data of the downsampling network of the i^{th} denoising network; and obtain input data of an upsampling network of the i^{th} denoising network based on the output data of the i^{th} bypass network and the output data of the downsampling network of the i^{th} denoising network, and input the text representation and the input data of the upsampling network of the i^{th} denoising network into the upsampling network of the i^{th} denoising network, to obtain an i^{th} output representation, i being a positive integer less than or equal to T, a first input representation being the latent space representation, the i^{th} output representation being used as an (i+1)^{th} input representation, and a T^{th} output representation being the denoised latent space representation.

In some embodiments, the i^{th} bypass network and the downsampling network of the i^{th} denoising network have a same structure, the i^{th} bypass network including N cascaded first network units, and the downsampling network of the i^{th} denoising network including N cascaded second network units, N being an integer greater than 1. Weighted summation is performed on output data of a j^{th} first network unit included in the i^{th} bypass network and output data of a j^{th} second network unit included in the downsampling network of the i^{th} denoising network, and then a result of the weighted summation is used as input data of a (j+1)^{th} second network unit, j being a positive integer less than N.

Through the technical solutions provided in the embodiments of the present disclosure, the representation extraction module generates the text representation of the input text, so that the generated text representation may represent feature information of the input text in a diversified manner, thereby improving functional diversity of the image generation model. The character name can be represented more comprehensively through a representation mean, so that a generated character image can adapt to more general application requirements, and the input text can be represented in a targeted manner by selecting a character representation with a highest similarity with an original character representation, so that the generated character image can match the input text more closely, thereby satisfying more diversified image generation requirements.

When the apparatus provided in the foregoing embodiment implements the functions of the apparatus, only division of the foregoing function modules is used as an example for description. In practical application, the functions may be allocated to and completed by different function modules as required. In other words, a content structure of the device is divided into different function modules, to complete all or some of the functions described above. In addition, the apparatus provided in the foregoing embodiment belongs to the same idea as the method embodiment. For a specific implementation process thereof, reference is made to the method embodiment. Details are not described herein again.

FIG. 20 is a structural block diagram of a computer device 2000 according to an embodiment of the present disclosure. The computer device 2000 may be any electronic device having data calculating, processing, and storage functions. The computer device 2000 may be configured to implement the training method for an image generation model or the image generation method based on an image generation model provided in the foregoing embodiments.

Generally, the computer device 2000 includes a processor 2001 and a memory 2002.

The processor 2001 may include one or more processing cores, for example, a 4-core processor or an 8-core processor. The processor 2001 may be implemented in at least one hardware form of digital signal processing (DSP), a field programmable gate array (FPGA), and a programmable logic array (PLA). The processor 2001 may alternatively include a main processor and a coprocessor. The main processor is a processor configured to process data in a wake-up state, which is also referred to as a central processing unit (CPU). The coprocessor is a low-power processor configured to process data in a standby state. In some embodiments, the processor 2001 may have a graphics processing unit (GPU) integrated therein. The GPU is configured to render and draw content that needs to be displayed on a display screen. In some embodiments, the processor 2001 may further include an AI processor. The AI processor is configured to process computing operations related to machine learning.

The memory 2002 may include one or more computer-readable storage media. The computer-readable storage medium may be non-transient. The memory 2002 may further include a high-speed random access memory (RAM) and a nonvolatile memory, for example, one or more disk storage devices or flash storage devices. In some embodiments, the non-transient computer-readable storage medium in the memory 2002 is configured to store a computer program, the computer program being executed by one or more processors, to implement the foregoing training method for an image generation model or the image generation method based on an image generation model.

A person skilled in the art may understand that the structure shown in FIG. 20 does not constitute a limitation on the computer device 2000, and the computer device may include more or fewer components than those shown in the figure, or some merged components, or different component arrangements.

In an exemplary embodiment, a computer-readable storage medium is further provided, having a computer program stored therein, the computer program, when executed by a processor of a computer device, implementing the foregoing training method for an image generation model or the image generation method based on an image generation model. In some embodiments, the foregoing computer-readable storage medium may be a read-only memory (ROM), a RAM, a compact disc ROM (CD-ROM), a magnetic tape, a floppy disk, an optical data storage device, and the like.

In an exemplary embodiment, a computer program product is further provided, including a computer program, the computer program being stored in a computer-readable storage medium. A processor of a computer device reads the computer program from the computer-readable storage medium, and the processor executes the computer program, so that the computer device performs the foregoing training method for an image generation model or the image generation method based on an image generation model.

In the present disclosure, a prompt interface and a pop-up window may be displayed or voice prompt information may be outputted before and during collection of relevant data of a user. The prompt interface, the pop-up window, or the voice prompt information is configured for prompting the user that relevant data of the user is currently being collected. Therefore, in the present disclosure, relevant operations of obtaining user-related data are performed only after a confirmation operation performed by the user on the prompt interface or the pop-up window is obtained. Otherwise (i.e., when no confirmation operation performed by the user on the prompt interface or the pop-up window is obtained), the relevant operations of obtaining user-related data are ended, i.e., the relevant data of the user is not obtained. In other words, all user data (including character name data and character image data) collected in the present disclosure is processed in strict accordance with requirements of relevant national laws and regulations, and informed consent or individual consent of a subject of personal information is collected with consent and authorization of the user. Within the scope of authorization of laws and regulations and the subject of personal information, subsequent use and processing behaviors of data are carried out, and the collection, use, and processing of relevant user data need to comply with the relevant laws, regulations, and standards of relevant countries and regions.

A term “a plurality of” mentioned herein means two or more than two. A term “and/or” describes an association relationship for describing associated objects and represents that three relationships may exist. For example, A and/or B may represent the following three cases: only A exists, both A and B exist, and only B exists. The character “/” generally indicates an “or” relationship between a preceding associated object and a succeeding associated object. In addition, the operation numbers described in this specification merely exemplarily show a possible execution sequence of the operations. In some other embodiments, the operations may not be performed according to the number sequence. For example, two operations with different numbers may be performed simultaneously, or two operations with different numbers may be performed according to a sequence contrary to the sequence shown in the figure. This is not limited in the embodiments of the present disclosure.

The technical solutions provided in the embodiments of the present disclosure may bring the following beneficial effects. On the one hand, the bypass module is added to the image generation model, so that during iterative training of the image generation model, only the representation extraction module and the bypass module may be trained, and the diffusion model does not need to be trained, to avoid a problem of model overfitting caused by the diffusion model forgetting a trained parameter as a result of training the pre-trained diffusion model again, thereby improving quality of an image generated by the model. On the other hand, the used training sample set includes a plurality of character images corresponding to a same character name, so that the trained image generation model may generate different character representations of the same character name, thereby meeting different character image generation requirements and improving functional diversity of the image generation model.

The foregoing descriptions are merely exemplary embodiments of the present disclosure, and are not intended to limit the present disclosure. Any modification, equivalent replacement, or improvement made within the spirit and principle of the present disclosure falls within the protection scope of the present disclosure.

What is claimed is:

1. A training method for an image generation model, performed by a computer device, and the method comprising:
obtaining a training sample set of the image generation model, the training sample set comprising at least one image-text pair, and each image-text pair comprising a character name and a character image that have a matching relationship;
inputting the character name in the image-text pair into a representation extraction module of the image generation model to generate a character representation corresponding to the character name;
inputting a random noise image into a forward processing module of a diffusion model of the image generation model to generate a latent space representation corresponding to the random noise image, the diffusion model being pre-trained;
inputting the character representation and the latent space representation into a backward processing module of the diffusion model and a bypass module of the image generation model, to generate a predicted image corresponding to the character name; and
adjusting parameters of the representation extraction module and the bypass module based on a difference between the predicted image and the character image, to obtain a trained image generation model.

2. The method according to claim 1, wherein inputting the character representation and the latent space representation into the backward processing module of the diffusion model and the bypass module, to generate the predicted image corresponding to the character name comprises:
inputting the character representation and the latent space representation into the backward processing module of the diffusion model and the bypass module, and denoising the latent space representation for T times based on the character representation through the backward processing module of the diffusion model and the bypass module, to obtain a denoised latent space representation, T being a positive integer; and
decoding the denoised latent space representation through a first decoder, to generate a predicted image corresponding to the character name.

3. The method according to claim 2, wherein the backward processing module of the diffusion model comprises T denoising networks, the denoising networks comprising a downsampling network and an upsampling network, and the bypass module comprising T bypass networks; and
inputting the character representation and the latent space representation into the backward processing module of the diffusion model and the bypass module, and denoising the latent space representation for T times based on the character representation through the backward processing module of the diffusion model and the bypass module, to obtain the denoised latent space representation comprise:
respectively inputting, in an i^{th} denoising process, the character representation and an i^{th} input representation into an i^{th} bypass network and a downsampling network of an i^{th} denoising network, to obtain output data of the i^{th} bypass network and output data of the downsampling network of the i^{th} denoising network;
obtaining input data of an upsampling network of the i^{th} denoising network based on the output data of the i^{th} bypass network and the output data of the downsampling network of the i^{th} denoising network; and
inputting the character representation and the input data of the upsampling network of the i^{th} denoising network into the upsampling network of the i^{th} denoising network, to obtain an i^{th} output representation,
i being a positive integer less than or equal to T, a first input representation being the latent space representation, the i^{th} output representation being used as an (i+1)^{th} input representation, and a T^{th} output representation being the denoised latent space representation.

4. The method according to claim 3, wherein the i^{th} bypass network and the downsampling network of the i^{th} denoising network have a same structure, the i^{th} bypass network comprising N cascaded first network units, and the downsampling network of the i^{th} denoising network comprising N cascaded second network units, N being an integer greater than 1; and
performing weighted summation on output data of a j^{th} first network unit comprised in the i^{th} bypass network and output data of a j^{th} second network unit comprised in the downsampling network of the i^{th} denoising network, and using a result of the weighted summation as input data of a (j+1)^{th} second network unit, j being a positive integer less than N.

5. The method according to claim 3, further comprising:
using a parameter of the downsampling network of the i^{th} denoising network as an initialized parameter of the i^{th} bypass network.

6. The method according to claim 1, wherein obtaining the training sample set of the image generation model comprises:
obtaining at least one original character image corresponding to the character name;
inputting at least one makeup picture and the at least one original character image into a face makeup application model, to generate at least one makeup-applied character image corresponding to the at least one original character image, one original character image and one makeup picture being configured to generate a makeup-applied character image; and
performing selection on the at least one makeup-applied character image to obtain an image-text pair in the training sample set.

7. The method according to claim 6, further comprising:
inputting the at least one makeup-applied character image into a face super-resolution model, to generate a super-resolution character image corresponding to the at least one makeup-applied character image, a resolution of the super-resolution character image being greater than a resolution of the makeup-applied character image; and
performing the selection on the at least one makeup-applied character image to obtain the image-text pair in the training sample set comprises:
performing selection on the at least one makeup-applied character image and the super-resolution character image corresponding to the at least one makeup-applied character image, to obtain the image-text pair in the training sample set.

8. The method according to claim 7, wherein performing selection on the at least one makeup-applied character image and the super-resolution character image corresponding to the at least one makeup-applied character image, to obtain the image-text pair in the training sample set comprises:
performing quality scoring on each character image in the at least one makeup-applied character image and the super-resolution character image corresponding to the at least one makeup-applied character image, to obtain a score corresponding to each character image;
selecting, from each character image, at least one character image whose score satisfies a condition as at least one character image having a matching relationship with the character name; and
obtaining at least one image-text pair in the training sample set based on the character name and the at least one character image having a matching relationship with the character name.

9. The method according to claim 1, wherein adjusting the parameters of the representation extraction module and the bypass module based on the difference between the predicted image and the character image, to obtain the trained image generation model comprises:
calculating a loss function value based on the difference between the predicted image and the character image; and
performing a plurality of rounds of iterative adjustment on the parameters of the representation extraction module and the bypass module based on the loss function value, to obtain the trained image generation model,
each round of iterative adjustment being configured for adjusting the parameter of one of the representation extraction module and the bypass module, a parameter of the other module remaining unchanged, and the parameters of the representation extraction module and the bypass module being adjusted alternately.

10. A computer device, comprising one or more processors and a memory containing a computer program that, when being executed, causes the one or more processors to perform:
obtaining a training sample set of an image generation model, the training sample set comprising at least one image-text pair, and each image-text pair comprising a character name and a character image that have a matching relationship;
inputting the character name in the image-text pair into a representation extraction module of the image generation model to generate a character representation corresponding to the character name;
inputting a random noise image into a forward processing module of a diffusion model of the image generation model to generate a latent space representation corresponding to the random noise image, the diffusion model being pre-trained;
inputting the character representation and the latent space representation into a backward processing module of the diffusion model and a bypass module of the image generation model, to generate a predicted image corresponding to the character name; and
adjusting parameters of the representation extraction module and the bypass module based on a difference between the predicted image and the character image, to obtain a trained image generation model.

11. The device according to claim 10, wherein the one more processors are further configured to perform:
inputting the character representation and the latent space representation into the backward processing module of the diffusion model and the bypass module, and denoising the latent space representation for T times based on the character representation through the backward processing module of the diffusion model and the bypass module, to obtain a denoised latent space representation, T being a positive integer; and
decoding the denoised latent space representation through a first decoder, to generate a predicted image corresponding to the character name.

12. The device according to claim 11, wherein the backward processing module of the diffusion model comprises T denoising networks, the denoising networks comprising a downsampling network and an upsampling network, and the bypass module comprising T bypass networks; and
the one more processors are further configured to perform:
respectively inputting, in an i^{th} denoising process, the character representation and an i^{th} input representation into an i^{th} bypass network and a downsampling network of an i^{th} denoising network, to obtain output data of the i^{th} bypass network and output data of the downsampling network of the i^{th} denoising network;
obtaining input data of an upsampling network of the i^{th} denoising network based on the output data of the i^{th} bypass network and the output data of the downsampling network of the i^{th} denoising network; and
inputting the character representation and the input data of the upsampling network of the i^{th} denoising network into the upsampling network of the i^{th} denoising network, to obtain an i^{th} output representation,
i being a positive integer less than or equal to T, a first input representation being the latent space representation, the i^{th} output representation being used as an (i+1)^{th} input representation, and a T^{th} output representation being the denoised latent space representation.

13. The device according to claim 12, wherein the i^{th} bypass network and the downsampling network of the i^{th} denoising network have a same structure, the i^{th} bypass network comprising N cascaded first network units, and the downsampling network of the i^{th} denoising network comprising N cascaded second network units, N being an integer greater than 1; and
performing weighted summation on output data of a j^{th} first network unit comprised in the i^{th} bypass network and output data of a j^{th} second network unit comprised in the downsampling network of the i^{th} denoising network, and using a result of the weighted summation as input data of a (j+1)^{th} second network unit, j being a positive integer less than N.

14. The device according to claim 12, further comprising:
using a parameter of the downsampling network of the i^{th} denoising network as an initialized parameter of the i^{th} bypass network.

15. The device according to claim 10, wherein the one more processors are further configured to perform:
obtaining at least one original character image corresponding to the character name;
inputting at least one makeup picture and the at least one original character image into a face makeup application model, to generate at least one makeup-applied character image corresponding to the at least one original character image, one original character image and one makeup picture being configured to generate a makeup-applied character image; and
performing selection on the at least one makeup-applied character image to obtain an image-text pair in the training sample set.

16. The device according to claim 15, further comprising:
inputting the at least one makeup-applied character image into a face super-resolution model, to generate a super-resolution character image corresponding to the at least one makeup-applied character image, a resolution of the super-resolution character image being greater than a resolution of the makeup-applied character image; and
the one more processors are further configured to perform:
performing selection on the at least one makeup-applied character image and the super-resolution character image corresponding to the at least one makeup-applied character image, to obtain the image-text pair in the training sample set.

17. The device according to claim 16, wherein the one more processors are further configured to perform:
performing quality scoring on each character image in the at least one makeup-applied character image and the super-resolution character image corresponding to the at least one makeup-applied character image, to obtain a score corresponding to each character image;
selecting, from each character image, at least one character image whose score satisfies a condition as at least one character image having a matching relationship with the character name; and
obtaining at least one image-text pair in the training sample set based on the character name and the at least one character image having a matching relationship with the character name.

18. The device according to claim 10, wherein the one more processors are further configured to perform:
calculating a loss function value based on the difference between the predicted image and the character image; and
performing a plurality of rounds of iterative adjustment on the parameters of the representation extraction module and the bypass module based on the loss function value, to obtain the trained image generation model,
each round of iterative adjustment being configured for adjusting the parameter of one of the representation extraction module and the bypass module, a parameter of the other module remaining unchanged, and the parameters of the representation extraction module and the bypass module being adjusted alternately.

19. A non-transitory computer-readable storage medium containing a computer program that, when being executed, causes the one or more processors to perform:
obtaining a training sample set of an image generation model, the training sample set comprising at least one image-text pair, and each image-text pair comprising a character name and a character image that have a matching relationship;
inputting the character name in the image-text pair into a representation extraction module of the image generation model to generate a character representation corresponding to the character name;
inputting a random noise image into a forward processing module of a diffusion model of the image generation model to generate a latent space representation corresponding to the random noise image, the diffusion model being pre-trained;
inputting the character representation and the latent space representation into a backward processing module of the diffusion model and a bypass module of the image generation model, to generate a predicted image corresponding to the character name; and
adjusting parameters of the representation extraction module and the bypass module based on a difference between the predicted image and the character image, to obtain a trained image generation model.

20. The storage medium according to claim 19, wherein the at least one processor is further configured to perform:
inputting the character representation and the latent space representation into the backward processing module of the diffusion model and the bypass module, and denoising the latent space representation for T times based on the character representation through the backward processing module of the diffusion model and the bypass module, to obtain a denoised latent space representation, T being a positive integer; and
decoding the denoised latent space representation through a first decoder, to generate a predicted image corresponding to the character name.
